(19) United States
(12) Patent Application Publication
(10) Pub. No.: US 2020/0265184 A1
(43) Pub. Date: Aug. 20, 2020

(54) CONTENT CONVERSION SYSTEM

(71) Applicant: SKRITSWAP INC., Sault Ste. Marie (CA)

(72) Inventors: Melissa KARGIANNAKIS, Sault Ste. Marie (CA); Darren REDFERN, Stratford (CA); Paras JAMIL, Mississauga (CA)

(21) Appl. No.: 16/789,720

(22) Filed: Feb. 13, 2020

Related U.S. Application Data
(60) Provisional application No. 62/806,118, filed on Feb. 15, 2019.

(51) Int. Cl. G06F 40/151; G06N 5/04; G06N 20/00; G06F 40/211; G06F 40/30; G06F 40/247; G06F 40/163

(52) U.S. Cl. CPC G06F 40/151; G06N 5/04; G06N 20/00; G06F 40/163; G06F 40/30; G06F 40/247; G06F 40/211

(57) ABSTRACT

A computer-implemented method for transforming comprehensibility of text, includes: receiving a body of text; partitioning the body of text into hierarchical syntactic and semantic segments; determining an initial comprehensibility level of the body of text, based on one or more metrics such as vocabulary, grammatical structure, voice, verb usage and formatting of the body of text; receiving a target comprehensibility level for the metrics; for each measure of complexity, including semantics and syntax, generating at least one transformation of that measure of complexity for a segment of the body of the text, based at least in part on the initial comprehensibility level and the target comprehensibility level; upon a confidence level for the transformation being greater than a predetermined threshold, performing the transformation on the segment of the body of text to generate a revised body of text; and determining a revised comprehensibility level.

### CROSS-REFERENCE TO RELATED APPLICATIONS

This application claims priority from U.S. Provisional Application No. 62/806,118 filed Feb. 15, 2019, the contents of which are hereby incorporated by reference.

### FIELD

This relates to language processing, in particular analysis and conversion of natural language.

### BACKGROUND

Written text may be analyzed by means of a computing device to determine its readability, complexity and/or consistency, and modifications may be made to the text to change the complexity or otherwise modify the style of the text.

Traditional techniques for using a computing device to automatically modify the complexity of written text (represented, for example, as a readability level) may be achieved by modifying or transforming text on the basis of only a limited number of variables, for example, by modifying the length of words and sentences in the text.

However, many variables, such as content, style, format, and organization all affect complexity of written text, and such variables are related, such that modification of one may affect another. As such, inconsistent application of text transformations across variables may result in inconsistent outcomes, and the goal of overall modification of the text may not be achieved.

Furthermore, such text transformations are typically performed without confirmation of the efficacy of the transformation in achieving the targeted goal of modifying the complexity of the text, and do not have the capability to evolve over time based on the successes or failures of particular transformations or other feedback mechanisms.

### SUMMARY

According to an aspect, there is provided a computer-implemented method for transforming comprehensibility of text, comprising: receiving a body of text; partitioning the body of text into hierarchical syntactic and semantic segments; determining an initial comprehensibility level of the body of text, based on one or more metrics, the metrics comprising vocabulary, grammatical structure, voice, verb usage and formatting of the body of text; receiving a target comprehensibility level for the metrics; for each of a plurality of measures of complexity, the measures of complexity including semantics and syntax: generating at least one transformation of that measure of complexity for a segment of the body of the text, based at least in part on the initial comprehensibility level and the target comprehensibility level; determining a confidence level for the transformation; and upon the confidence level being greater than a predetermined threshold, performing the transformation on the segment of the body of text to generate a revised body of text; and determining a revised comprehensibility level for the revised body of text based on each transformation performed on the body of text.

In some embodiments, the syntactic segments comprise structural treebanks.

In some embodiments, the semantic segments comprise dependency treebanks.

In some embodiments, the initial comprehensibility level is based at least in part on a density of clauses in the body of text, a density of content words in the body of text, and a ratio of whitespace in the body of text.

In some embodiments, the density of clauses in the body of text is based at least in part on a number of independent clauses in the body of text, a number of dependent clauses in the body of text, a number of prepositional phrases in the body of text, and a number of sentences in the body of text.

In some embodiments, the density of content words is based at least in part on a number of content words in the body of text and a number of total words in the body of text.

In some embodiments, the ratio of whitespace in the body of text is based at least in part on a total number of characters in the body of text, and a number of whitespace characters in the body of text.

In some embodiments, the transformation of syntax comprises one or more of changing sentence structure of the segment of the body of text and a replacement of word dependencies.

In some embodiments, the transformation of semantics comprises one or more of a replacement of voice usages, a replacement of verb tense, and a replacement of vocabulary.

In some embodiments, the transformation of semantics comprises: identifying a synset of a word in the segment, the synset including a set of synonyms for the word, each synonym associated with a numerical indicator of a comprehensibility level of that synonym; replacing the word with a replacement synonym from the synset; and revising the numerical indicator associated with the replacement synonym.

In some embodiments, the measures of complexity include presentation of the body of text.

In some embodiments, the presentation of the body of text includes at least one of formatting, whitespace, sizing, and spacing.

In some embodiments, the transformation of presentation comprises a change of at least one of formatting, whitespace, sizing, and spacing.

In some embodiments, the confidence level is based at least in part on a number of users that have accepted the transformation and a number of users that have rejected the transformation.

In some embodiments, the revised comprehensibility level is based at least in part on a density of clauses in the revised body of text, a density of content words in the revised body of text, and a ratio of whitespace in the revised body of text.

In some embodiments, the method further comprises: determining an initial readability level of the body of text, based on one or more metrics, the metrics comprising vocabulary, grammatical structure, voice, verb usage and formatting of the body of text; receiving a target readability level for the metrics; and for each of the plurality of measures of complexity: generating at least one transformation in that measure of complexity for a segment of the body of the text, based at least in part on the initial readability level and the target readability level; determining a confidence level for the transformation; and upon the confidence level being greater than a predetermined threshold, performing the transformation on the segment of the body of text to generate the revised body of text; and determining a revised readability level for the revised body of text based on each transformation performed on the body of text.

In some embodiments, the initial readability level is based at least in part on a total number of words in the body of text, a total number of sentences in the body of text, and a total number of syllables in the body of text.

In some embodiments, the method further comprises: for each of the plurality of measures of complexity: upon the confidence level being less than the predetermined threshold, displaying the transformation to a user, receiving an input indicating whether the user accepts the transformation, updating the confidence level of the transformation based on the input, and performing the transformation on the segment of the body of text when the user accepts the transformation.

In some embodiments, the method further comprises: tracking user interactions of the user, and wherein the generating the at least one transformation is based at least in part on the user interactions.

According to another aspect, there is provided a computer-implemented method for determining comprehensibility of text, comprising: receiving a body of text; transform the body of text into segments; for each of the segments: evaluating a number of independent clauses, a number of dependent clauses, and a number of prepositional phrases in the segment; determining a density of clauses based at least in part on the number of independent clauses, the number of dependent clauses, and the number of prepositional phrases in the segment; evaluating a number of content words and a number of total words in the segment; determining a density of content words based at least in part on the number of content words and the number of total words in the segment; evaluating a total number of characters and a number of whitespace characters in the segment; determining a ratio of whitespace based at least in part on the total number of characters and the number of whitespace characters in the segment; and assign a relative weighting to each of the density of clauses, the density of content words, and the ratio of whitespace; and determining a comprehensibility level of the body of text based at least in part on the weighted density of clauses, the weighted density of content words and the density of the ratio of whitespace of each of the segments.

According to another aspect, there is provided a computer system comprising: a processor; and a memory in communication with the processor, the memory storing instructions that, when executed by the processor cause the processor to perform a method as described herein.

According to a further aspect, there is provided a non-transitory computer readable medium comprising a computer readable memory storing computer executable instructions thereon that when executed by a computer cause the computer to perform a method as described herein.

Other features will become apparent from the drawings in conjunction with the following description.

### BRIEF DESCRIPTION OF DRAWINGS

In the figures which illustrate example embodiments,

FIG. 1 is a schematic block diagram illustrating an operating environment of an example embodiment;

FIG. 2 is a block diagram of example hardware components of a computing device of the content conversion system of FIG. 1, according to an embodiment;

FIG. 3 illustrates the organization of software at the computing device of FIG. 2;

FIG. 4 is a block diagram of the content conversion system software of FIG. 3, according to an embodiment;

FIG. 5 is a block diagram of syntax analysis and mark-up software of FIG. 3, according to an embodiment;

FIG. 6 is a block diagram of conversion controller software of FIG. 3, according to an embodiment;

FIG. 7 is a block diagram of leveled thesauri and dictionaries software of FIG. 4, according to an embodiment;

FIGS. 8A-8E illustrate examples of high-level pseudo-code of thesaurus software of FIG. 7; and

FIGS. 9A-9G illustrate examples of high-level pseudo-code of recommendation software of FIG. 7;

FIG. 10A is a flow chart of a method for content conversion, performed by the software of FIG. 3, according to an embodiment; and

FIG. 10B is a flow chart of a method for style guide automation, performed by the software of FIG. 3, according to an embodiment.

### DETAILED DESCRIPTION

Systems described herein may provide automated textual analysis and conversion techniques and be used to process and analyze language data, and in particular, written text, and evaluate and make conversions to the written text based on criteria such as readability, comprehensibility, consistency and style.

In some embodiments, human and machine methods may be combined to perform tasks for text conversion. By virtue of a series of checks and balances on data gathered and processes attempted, the content conversion system described herein may gradually (over time, as reliable learning is accumulated) switch off certain identified tasks from solely-human to human-aided to mostly-algorithmic to totally-automated. The system may independently identify which sets of tasks should be at which levels of automation at which times. Some tasks may become automated very quickly (e.g., vocabulary substitution) while others may not be completely automated (e.g., certain semantic transformations). When totally new areas or classes of content are encountered, the system may treat them primarily with human-based methods.

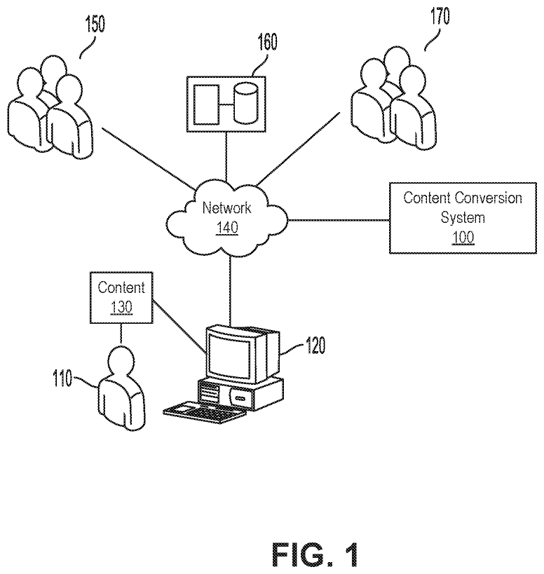

FIG. 1 is a schematic block diagram illustrating an operating environment of an example embodiment.

As illustrated, a client device 120 associated with a user 110 is in communication with a content conversion system 100 by way of a network 140. Network 140 may, for example, be a packet-switched network, in the form of a LAN, a WAN, the public Internet, a Virtual Private Network (VPN) or the like. User 110 may communicate or interact with content 130, such as a body of text for analysis and conversion, which may be, for example, stored on client device 120. Content conversion system 100 is in communication with external data 160, professionals 150 and other users 170 by way of network 140.

Client device 120 is associated with user 110, and may be, for example, a computing device such as a mobile device. Client device 120 may include, for example, personal computers, laptop computers, servers, workstations, supercomputers, smart phones, tablet computers, wearable computing devices, and the like. In at least some embodiments, mobile devices can also include without limitation, peripheral devices such as displays, printers, touchscreens, projectors, digital watches, cameras, digital scanners and other types of auxiliary devices that may communicate with another computing device.

Data on user 110 associated with client device 120, which may include a user identifier, may be stored at client device 120 and provided to content conversion system 100. Thus, the user's interactions with content conversion system 100 may be tracked, for example, to track a user's preferences, readability level and comprehensibility level over time.

Content 130 for conversion may include structured or unstructured text content and may be stored on client device 120.

Content 130 may be from sources such as documents, books, magazines, press releases, and news articles or the like, or electronic sources from the Internet, such as web pages, email, SMS messages, electronic books, or the like.

Content 130 may exist in a variety of formats, for example, such as plain text, enriched text, rich text, HyperText Markup Language (HTML), or other document markup language, Microsoft™ Word Binary File Format (.doc) or other document file format.

In some embodiments, content 130 may include text inputted by user 110 at client device 120, for example, by way of a peripheral.

Content conversion system 100, upon receiving content 130 from client device 120, may perform analysis and conversion of the text of content 130.

Content conversion system 100 may leverage both the reading/writing skills and reading challenges of a broad variety of users (as well as several existing linguistic resources) to build machine learning models to convert any content into any reading level, comprehensibility level or style.

Content conversion system 100 may provide a frozen-in-time picture of modified content, and learn and evolve over time, which may result in its outputs getting more usable and accurate over time—partly through the use of extensive feedback mechanisms with users and simplification experts.

Each granular piece of data that content conversion system 100 collects and leverages (in whatever way) to make automated or semi-automated conversions may be associated with a confidence value. The confidence value may be within a range between zero and one, with zero representing no confidence and one representing complete confidence.

These confidence levels may be used for deciding which conversions to make, whether to leverage human micro-input, whether to make an explicit substitution or merely a recommendation for substitution, and many other decisions.

An initial confidence for any particular piece of data may be set initially by the conditions in which it was gathered and then, over time, the confidence value is adjusted up or down depending on other human-based choices/actions within the system.

Events such as multiple users making the same (uninfluenced) choice can raise the confidence level on the data representing that choice. On the other hand, users not accepting a recommended conversion can lower the confidence on the data representing that choice. Confidence levels need not be set in stone—they may be able to change given new inputs to the system.

A document or body of text may be evaluated across various factors or variables to assess readability or comprehensibility. These variables, sometimes referred to as “dimensions” herein, may be broadly defined as semantics and syntax of the text. Thus, a “semantic” dimension may define a measure of complexity (such as “readability level” or “comprehensibility level”) of the text on the basis of a semantic analysis of the meaning of the text. Similarly, a “syntactic” dimension may define a measure of complexity (such as “readability level” or “comprehensibility level”) of the text on the basis of a syntactic analysis of the structure of the text.

“Dimensions” may be defined with further particularity, for example, under the umbrella of semantics or syntax. For example, dimensions may include length of sentences, length of words, dependency between words, vocabulary, approach, voice (e.g. active vs. passive), verb tense, person, tone, typography, design, and organization.

Content conversion system 100 may be configured to measure each dimension independently to get a list of individual readability and/or comprehensibility levels for things like vocabulary, structure, voice, verb usage, formatting, etc. Content conversion system 100 may transform text such that each of these dimensions of simplicity is within a certain tolerance of the target readability and/or comprehensibility level—to create an even feel to the document and maximize overall readability and comprehensibility. Also, content conversion system 100 may try to keep the confidence level for each dimension even across the entire document of text.

For conversions of content on the basis of readability level (such as a reading level or a grade level), content conversion system 100 may be configured to determine a readability level of text, for example, using readability level measurements such as Flesch-Kincaid and Coleman-Liau. Readability can be defined as a measure of how easy or difficult it is to read the words in a piece of content.

A target readability level may be received, for example, from user 110, and content conversion system 100 may perform various transformations, across dimensions and with consideration of associated confidence levels, to transform the text towards the target readability level.

Content conversion system 100 may measure the readability levels of individual pieces of training data gathered from operation of content conversion system 100. Content conversion system 100 may also track each individual end-user (that is, a reader of converted content), for example, user 110 or one of other users 170, to compile a detailed profile of their individual readability levels across all the various dimensions mentioned above.

A user's initial readability profile may be seeded by standard reading level tests, and may be tweaked over time in accordance with the user's interactions with the system. As well, these reader readability profiles may be used to track any improvement or deterioration in a user's reading capabilities over time.

Conversions of content may also be performed on the basis of comprehensibility level. Comprehension or comprehensibility can be defined as a measure of how easy or difficult it is to understand the meaning and purpose of words in a piece of content. A comprehensibility level may quantify a level of comprehensibility of any particular piece of content. Comprehension, in general, relies on a combination of language usage, vocabulary, formatting, layout, and the like. While comprehensibility is described herein in the context of the English language, it is understood that these concepts can extend to other languages and language families.

Content conversion system 100 may be configured to determine a comprehensibility level, or content comprehensibility measure (CCM), of text. A comprehensibility level can be measured for content based on measured factors that are represented, for example, by real variables. Factors contributing to a comprehensibility level can include a clause/phrase density (CPD), a content word density (CWD), a whitespace ratio (WSR), an average coreference distance (ACD), and a coreference density (CRD), and other variables as described in further detail below.

Conveniently, a measure of comprehensibility can help determine if a piece of content (for example, as-is) is appropriate for a specific audience.

A target comprehensibility level may be received, for example, from user 110, and content conversion system 100 may perform various transformations, across dimensions and with consideration of associated confidence levels, to transform the text towards the target comprehensibility level, for example, to make content more comprehensible.

Content conversion system 100 may measure the comprehensibility levels of individual pieces of training data gathered from operation of content conversion system 100. Content conversion system 100 may also track each individual end-user (that is, a reader of converted content), for example, user 110 or one of other users 170, to compile a detailed profile of their individual comprehensibility levels across all the various dimensions mentioned above.

A user's initial comprehensibility profile may be seeded at least in part by reading and comprehension level tests, and may be tweaked over time in accordance with the user's interactions with the system. As well, these reader comprehensibility profiles may be used to track any improvement or deterioration in a user's comprehensibility capabilities over time.

In some embodiments, text may evaluated on the basis of “consistency”. For example, “consistency”, or “style” may define use of a particular word instead of an alternative word with the same meaning. As such, text may be transformed on the basis of consistency.

Stylistic or consistency-based transformations may be, for example, substitution. In some embodiments, a transformation may provide a hint for the user on how to behave, for example, to conform to an organization's social media policies.

In some embodiments, a hybrid human-and-algorithm approach may be applied to text transformations such as taking complex textual content and converting it into a desired, simpler level of readability and/or comprehensibility.

In some embodiments, transformations as described herein may be performed on the basis of tiered permissions or a permission hierarchy, such that certain transformations may be prioritized based on a permission level of a user or a mechanism that has set or requested the transformation.

In an example, an administrator can set a transformation with a higher weight or priority, and thus the transformation is prioritized over other transformations set by other users or mechanisms that have a lower weight or priority. Certain transformations can thereby be overruled by a higher priority transformation. The weight or priority level can be based upon a position of authority or level of the user who defines the transformation. Other techniques for assigning weight or priority level of a transformation are contemplated, for example, based upon feedback from the system.

In an example, higher priority transformations are automatically performed, while lower priority transformations can be presented as optional.

Transformations may also be favourited by a user, such that favourited transformations are automatically performed for that particular user.

Certain transformations may thus be overruled by higher weight or priority transformations or favourited transformations.

In an example when multiple conflicting transformations are presented, a transformation with the highest priority or weight (for example, preference or set by a highest level user) would be performed, with the other transformations presented as suggestions such that an end-user is provided with an option to select a desired transformation.

Content conversion 100 may initially operate in a low-data situation but, over time, learns more and more from humans interacting with the system which allows it to automate more and more of the conversion process on future documents. Eventually, content conversion system 100 may only need human intervention for detailed discernment tasks and determining approaches to previously unseen types of content.

A skilled person would understand that content conversion system 100 may be local, remote, cloud based or software as a service platform (SaaS). As depicted, content conversion system 100 is implemented as a separate hardware device. Content conversion system 100 may also be implemented in software, hardware or a combination thereof on client device 120.

In some embodiments, content conversion system 100 may be implemented as an add-on to word processing software, such as Microsoft™ Word, or other modes or platforms of textual content and/or presentation such as Google™ Docs, Jira™, Slack™, and Facebook™.

In some embodiments, content conversion system 100 may be implemented in a computing device at an operating system level, and accessible by text-based or language-based applications.

One or more professionals 150, such as experts in various language fields, may interface with content conversion system 100 by way of human-based processes 1120 of recommendation software 340 (described below) to provide input to content conversion system 100, such as transformations to rewrite a specific segment of text (for example, a sentence) at a desired reading target level.

Content conversion system 100 interfaces with external data 160 which may include an external data repository and store partner data. External data 160 may include data such as training data, provided by an external source, and accessed by external data retrieval software 370, described in further detail below.

Other users 170 may also interact with content conversion system 100 in the same or similar manner as user 110.

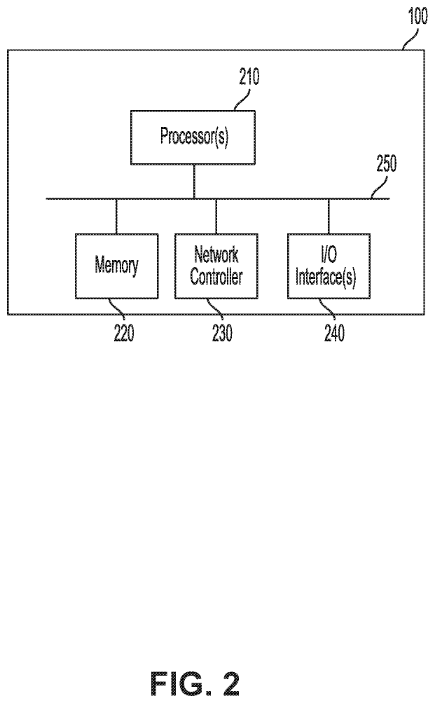

FIG. 2 is a high-level block diagram of a computing device, exemplary of a content conversion system 100. As will become apparent, content conversion system 100, under software control, may receive content 130 for processing by one or more processor(s) to convert content, for example, on the basis of a readability level, a comprehensibility level, and/or style.

As illustrated, content conversion system 100, a computing device, includes one or more processor(s) 210, memory 220, a network controller 230, and one or more I/O interfaces 240 in communication over bus 250.

Processor(s) 210 may be one or more Intel x86, Intel x64, AMD x86-64, PowerPC, ARM processors or the like.

Memory 220 may include random-access memory, read-only memory, or persistent storage such as a hard disk, a solid-state drive or the like. Read-only memory or persistent storage is a computer-readable medium. A computer-readable medium may be organized using a file system, controlled and administered by an operating system governing overall operation of the computing device.

Network controller 230 serves as a communication device to interconnect the computing device with one or more computer networks such as, for example, a local area network (LAN) or the Internet.

One or more I/O interfaces 240 may serve to interconnect the computing device with peripheral devices, such as for example, keyboards, mice, video displays, and the like. Optionally, network controller 230 may be accessed via the one or more I/O interfaces.

Software instructions are executed by processor(s) 210 from a computer-readable medium. For example, software may be loaded into random-access memory from persistent storage of memory 220 or from one or more devices via I/O interfaces 240 for execution by one or more processors 210. As another example, software may be loaded and executed by one or more processors 210 directly from read-only memory.

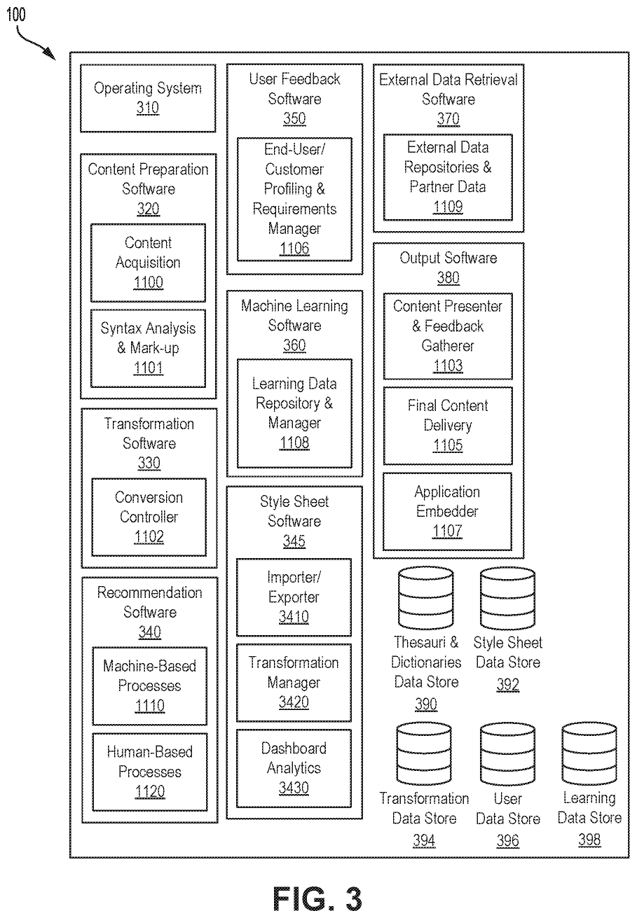

FIG. 3 depicts a simplified organization of example software components and data stored within memory 220 of content conversion system 100. As illustrated, these software components include operating system (OS) software 310, content preparation software 320, transformation software 330, recommendation software 340, style sheet software 345, user feedback software 350, machine learning software 360, external data retrieval software 370, output software 380, thesauri and dictionaries data store 390, style sheet data store 392, transformation data store 394, user data store 396, and learning data store 398.

Operating system 310 may allow basic communication and application operations related to the mobile device. Generally, operating system 310 is responsible for determining the functions and features available at the computing device, such as keyboards, touch screen, synchronization with applications, email, text messaging and other communication features as will be envisaged by a person skilled in the art. OS software 310 allows software of content conversion system 100 to access one or more processors 210, memory 220, network controller 230, and one or more I/O interfaces 240 of the computing device. OS software 310 may be, for example, Microsoft Windows, UNIX, Linux, Mac OSX, or the like.

Content preparation software 320 acquires content and extracts and formats text for further processing by content conversion system 100.

As illustrated, content preparation software 320 may include a content acquisition 1100 for acquiring content and a syntax analysis and mark-up 1101 for processing content for use by processes described herein.

Transformation software 330 oversees the analysis and transformation of text that has been prepared or formatted by content preparation software 320, and receives recommendations for transformations from recommendation software 340.

As illustrated, transformation software 330 may include a conversion controller 1102 for transforming text between readability levels, comprehensibility levels or styles, such as on the basis of style sheets stored in style sheet data store 392. Transformation data generated by transformation software 330 may be stored in transformation data store 394.

Recommendation software 340 makes content conversion recommendations for transformation software 330.

As illustrated, recommendation software 340 may include machine-based processes 1110 for making recommendations for content conversion based on machine-based intelligence and a human-based processes 1120 for making recommendations for content conversion based on human-based intelligence or interaction.

Style sheet software 345 manages style sheets stored in style sheet data store 392.

User feedback software 350 tracks interaction and feedback of user 110 and other users 170 with aspects of content conversion system 100.

As illustrated, user feedback software 350 may include an end-user/customer profiling and requirements manager 1106 for tracking user interactions with the overall content conversion system 100, for example, to compile a profile of each user's individual skills and requirements. User data may be stored in user data store 396.

Machine learning software 360 determines recommendations for content conversion to be performed by transformation software 330, as well as develop training sets of data to train machine learning models to process data using programming rules and code that can dynamically update over time. In some embodiments, machine learning software 360 is configured to learn from transformations made, for example, by transformation software 330, which may facilitate transformation software 330 performing in a more automated and more accurate way in future uses. Training data and machine learning models may be stored in learning data store 398.

As illustrated, machine learning software 360 may include a learning data repository and manager 1108 for storing and managing training data collected by content conversion system 100.

External data retrieval software 370 is configured to communicate with external data sources, for example external data 160, to receive data for use by content conversion system 100.

As illustrated, external data retrieval software 370 may include external data repositories and partner data 1109 for receiving data, such as training data, from external or partner sources instead of through content conversion system 100 directly.

Output software 380 controls how content processed by content conversion system 100, for example, transformed text generated by transformation software 330, is output or displayed.

As illustrated, output software 380 may include a content presenter and feedback gatherer 1103 for formatting transformed text in preparation for presentation to a user such as user 110 as well as for soliciting and receiving feedback from users on transformations, final content delivery 1105 for delivering content to a user such as user 110 for external purposes, and application embedder 1107 for expressing transformations within other (e.g., external) applications in which digital content is being created, edit, or curated.

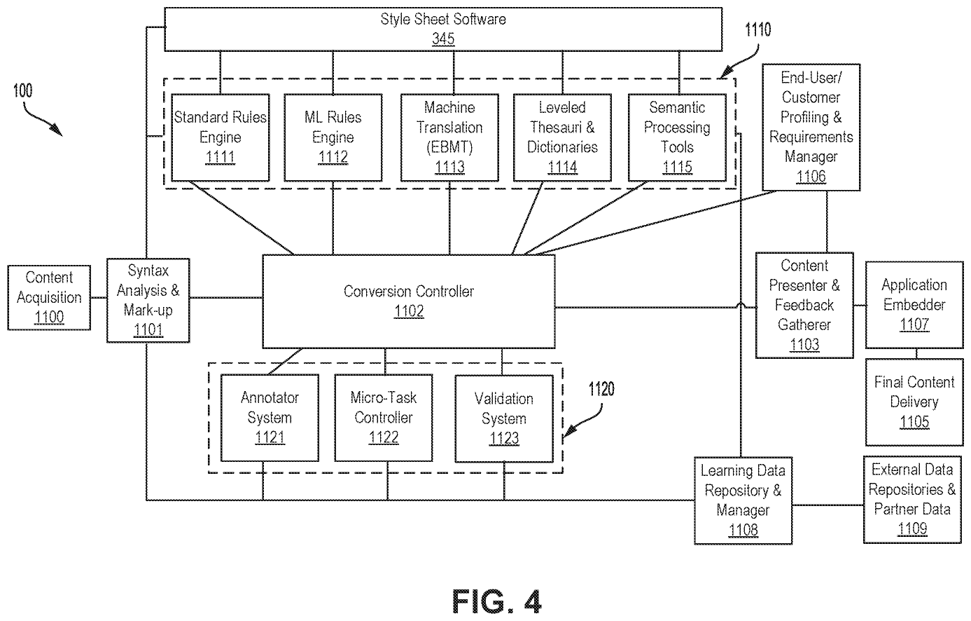

FIG. 4 is a block diagram illustrating communication between content conversion system 100 software, according to an embodiment.

As shown in FIG. 4, content acquisition 1100 communicates with syntax analysis and mark-up 1101. Syntax analysis and mark-up 1101, in turn, communicates with conversion controller 1102. Conversion controller 1102 communicates with machine-based processes 1110, human-based processes 1120, content presenter and feedback gatherer 1103 and end-user customer profiling and requirements manager 1106. Machine-based processes 1110 and human-based processes 1120 further communicate with syntax analysis and mark-up 1101. Content presenter and feedback gatherer 1103 also receives end-user and customer feedback and communicates with application embedder 1107 and final content delivery 1105, as well as end-user/customer profiling and requirements manager 1106. Syntax analysis and mark-up 1101 communicates with learning data repository and manager 1108. Learning data repository and manager 1108 communicates with end-user/customer profiling and requirements manager 1106 and external data repositories and partner data 1109.

Content acquisition 1100 is configured to acquire content for conversion by content conversion system 100. In an example, a user interface (UI) may be provided to user 110 at computing device 120 to acquire content 130 in the form of a target document. Once content 130 is acquired, content acquisition 1100 may request that user 110 input a target readability level (TRL) for content 130, as the desired readability level for content 130 following conversion, and a target comprehensibility level (TCL) for content 130, as the desired comprehensibility level for content 130 following conversion.

Content acquisition 1100 may send content 130, such as plain text, a target document, target readability level (TRL), and target comprehensibility level (TCL) data to syntax analysis and mark-up 1101.

Syntax analysis and mark-up 1101 may receive content 130, target readability level (TRL), and target comprehensibility level (TCL) data from content acquisition 1100.

Data such as TRL and TCL may be added to a larger document data structure.

In some embodiments, syntax analysis and mark-up 1101 processes the target document of content 130 to transform it into a format that can be utilized by processes that follow.

Syntax analysis and mark-up 1101 may be configured to perform multi-level syntactical analysis in order to mark each token (word) and structure (phrase, clause, sentence, etc.) in the content to support transformations in conversion controller 1102.

Syntax analysis and mark-up 1101 may analyze content 130 to tokenize content 130 both syntactically and structurally, for example, on the basis of phrases, sentences, and words. Parts of speech may then be identified for one or more words and a word sense defined for one or more words.

Parts of speech provide a category to which a word is assigned in accordance with its syntactic functions. For example, parts of speech in English include noun, pronoun, adjective, determiner, verb, adverb, preposition, conjunction, and interjection.

Word sense provides a meaning of a word, which can be used in different senses. For example, syntax analysis and mark-up 1101 may define “bank” as a side of a river, or “bank” as a financial institution.

Thus, it may be possible to identify a part of speech and word sense for a particular word, such that it is possible to identify, for example, a noun and the level or usage of said noun as used in the context of the remaining content 130.

In some embodiments, treebank analysis is performed on content 130 to generate structural treebanks and dependency treebanks for use by conversion controller 1102, for example, for transformations.

In some embodiments, a structural treebank or tree may be generated using suitable natural language processing techniques performed on content 130.

A structural treebank, also referred to as a constituency or grammatical treebank, may be used to break sentences into phrases and subphrases, to examine grammatical structure and identify part of speech and word sense.

A structural treebank may define a pre-ordained set of possible transformations, and the treebank can thus represent transformations that are present or possible to be performed on content 130.

In some embodiments, structural information may be extracted from a treebank and used to reconstruct the tree. A sentence can then be written from the reconstructed tree.

Reconstruction can include, for example, transformation (such as grammatical), substitution, or re-ordering. Reconstruction may be made possible by encoded rules applied to certain content by way of treebanks, which provide non-trivial structure.

In an example, a structural treebank may be parsed to indicate that a phrase at the beginning of a sentence can be moved after the primary phrase of a sentence, with a comma between them. Such parsing can be used to rearrange, split, or suggest alternative usage.

In another example, a semi-colons list can be identified as replaceable by bullet points. By contrast, two sentences separated by semi-colon, may be transformed into two sentences.

A dependency treebank may be used to examine what word is defined by what other word, namely, what words draw their meaning from what other words. For example, for a pronoun referring back to another word, a dependency treebank can identify that the pronoun draws meaning from what other noun. Thus, a dependency treebank may be used to represent the semantic meaning of a sentence.

In an example, a sentence such as “John ate an apple yesterday which was red” can be parsed using a dependency parsing to determine that the term “yesterday” refers to “ate” and “which was red” refers to “apple”.

Dependency trees may be used to apply coreference resolution to determine all expressions that refer to the same entity in a text.

Such dependencies may be used for transformation in syntax including replacement of dependencies such as word dependencies.

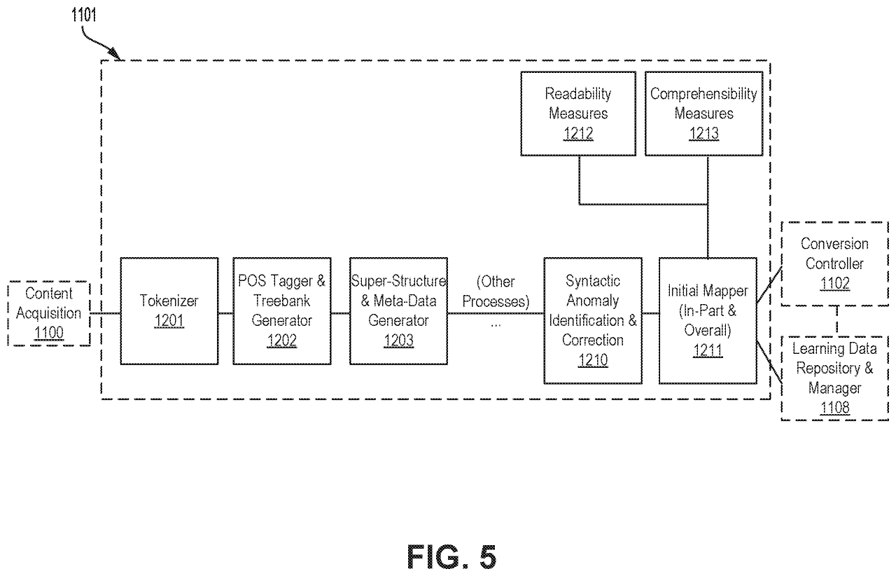

Preparation of content 130 for use in various components of content conversion system 100 and use in the training data repository is illustrated in FIG. 5 and described in more detail below.

Syntax analysis and mark-up 1101 may send marked-up and analyzed target content, and individual training data elements to conversion controller 1102 and learning data repository and manager 1108.

In addition, syntax analysis and mark-up 1101 may be used to analyze and mark-up content that is entered by human-based methods, including human-based processes 1120 such as annotator system 1121, micro-task controller 1122, and validation system 1123. These human inputs may be added to learning data repository and manager 1108, which may improve the automation of the overall system.

Conversion controller 1102 may receive marked-up/analyzed target content 130, user profile for user 110, and individual conversion inputs data from syntax analysis and mark-up 1101, content presenter and feedback gatherer 1103, end-user and customer profiling and requirements manager 1106, machine-based processes 1110 and human-based processes 1120.

Using a broad variety of human- and machine-based techniques and data, conversion controller 1102 is configured to transform the target content 130, for example, into a well-structured, dimensionally-even, high-confidence version that can be comprehended by each particular user at their level of readability and/or comprehensibility (or at the enterprise customer's preferred general target level). In some embodiments, transformation of content 130 may be on the basis of stylistic guidelines. As part of the process, conversion controller 1102 may learn from transformations made in order to perform in a more (and more accurate) automated way in future uses.

In some embodiments, transformation of content 130 can include identifying that a certain transformation is relevant, and actually performing the transformation that is applicable.

In some embodiments, transformations may be performed on the basis of a particular style guide, for example, a style sheet stored in style sheet data store 392 as managed by style sheet software 345. A style sheet can include transformation rules that include changes on the basis of one of more of vocabulary, grammatical structure, voice, verb usage and formatting of the body of text. For example, a style sheet may suggest an actual substitution, or a suggestion. For example, if the term “social media” is used, a suggestion may be provided to a user to replace the term with a more specific reference to Twitter™ or Facebook™, depending on the content.

In some embodiments, certain override or super-rules may be implemented to override or omit certain transformations, such as based on administrator decisions. In an example, a rule such as transforming independent clauses separate by semi-colons into separate sentences may be overridden. The toggleability of particular transformations can be customizable for a particular end-user, or between groups of end-users depending on the needs of the group.

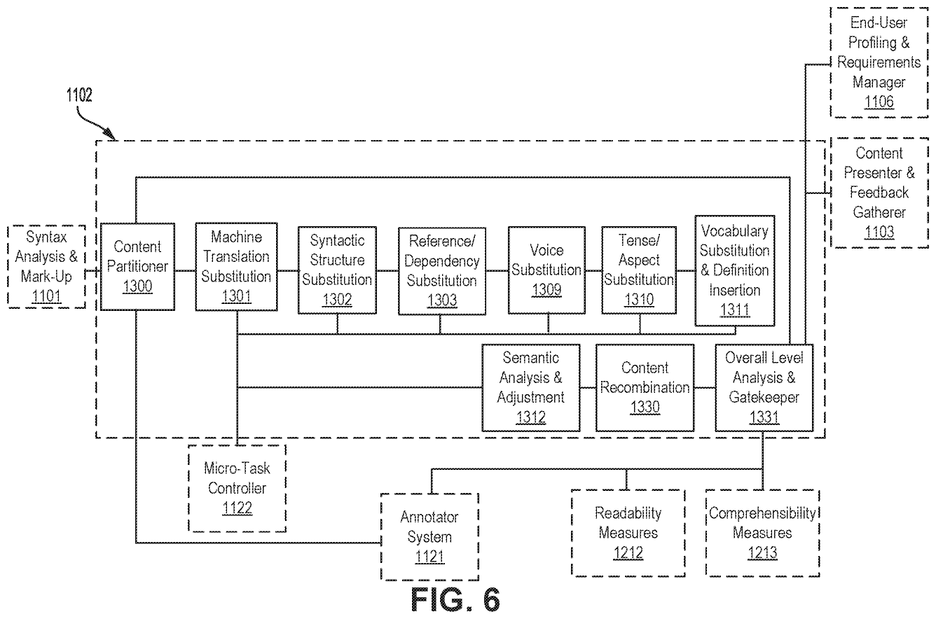

Techniques by which conversion controller 1102 takes the analyzed initial content supplied by the user and controls the process by which that content is transformed, is illustrated in FIG. 6 and described in more detail below.

Conversion controller 1102 coordinates and controls at the highest level all actions taken in the process of converting input content 130 into output at a target reading level, comprehensibility level or style.

Certain processes within conversion controller 1102 have a knowledge of the detailed capabilities of the overall system (i.e., how “smart” the system currently is) in each dimension of conversion, and leverage this information to determine which sub-components to invoke (and which not to invoke) accordingly. In the same vein, conversion controller 1102 also manages when to apply automated techniques or human-based techniques in any particular dimension of conversion—based on the current confidence in its automated learnings. So, if the automated learnings have a low confidence, the system may use human-based assets to perform the required actions—and learns from those actions to improve its automated processes for the next time. In some embodiments, conversion controller 1102 may examine possible transformations and then each one individually, look at confidence level for that transformation and then decide which transformation to perform.

As well, conversion controller 1102 may ensure that the input content 130 is simplified evenly along all dimensions of conversion.

To accomplish these tasks, conversion controller 1102 calls upon a variety of techniques (e.g., machine translation, vocabulary substitution, etc.) and also receives from these techniques information about the effectiveness and limits of their conversions, both generally and specific to the content they just received. This information is used to determine when the system should try other techniques and when, ultimately, it needs to identify what can be accomplished automatically.

Every transformation, for example as recommended by machine-based processes 1110, whether grammatical, machine learning, thesaurus-based, or otherwise, may have readability level and/or comprehensibility level information, or “levelling info”, attached to it. For example, a semi-colon may be converted to a period only if converting to a reading level at grade 10 reading level or below. The transformation is thus dependent on the target reading level and/or comprehensibility level.

Furthermore, a confidence level may be applied to an understanding of whether there is sufficient proof that this change is being recognized appropriately. For example, if a number of users reject a transformation, the confidence level reduces. Confidence may be based on a frequency of use, and vary based on user feedback. The value of a readability level and/or comprehensibility level associated with a particular transformation may also move concurrently with the movement of the readability levels and/or comprehensibility levels of those users accepting the transformation, and confidence increases.

Conversion controller 1102 also tracks the techniques used (and tried) for each individual piece of content converted, creating an “audit trail” that is available for machine learning purposes but also for review by the administrators and users.

Conversion controller 1102 may output raw converted content (both finalized and potential) to content presenter and feedback gatherer 1103.

Machine-based processes 1110 is a collection of subsystems making recommendations for content conversion. Each subsystem is based on machine-based intelligence (as opposed to human-based intelligence). These subsystems operate at widely variable levels of computational and AI/ML sophistication, as required by the types of recommendations they provide. In some cases, these subsystems also compute their own ML models, again using a variety of techniques.

Machine-based processes 1110 may receive training data from learning data repository and manager 1108, and output conversion instructions to conversion controller 1102.

As shown in FIG. 4, machine-based processes 1110 may include standard rules engine 1111, machine learning (“ML”) rules engine 1112, machine translation example-based machine transformations (“EBMT”) 1113, leveled thesauri and dictionaries 1114, and semantic processing tools 1115, each described in further detail below.

Further suitable machine-based subsystems may also be included, and machine-based techniques and operations may be added or removed to machine-based processes 1110 as desired.

Standard rules engine 1111 manages and recommends pre-set rules-based transformations, such as corporate rules. These transformations can be as simple as exact string substitutions, to regex rules, to complex syntactic manipulations.

Standard rules engine 1111 may send conversion instructions to conversion controller 1102.

ML rules engine 1112 may receive training data from learning data repository and manager 1108.

ML rules engine 1112 manages and recommends machine learning rules-based transformations. The models for these recommendations may be computed from training data already in the system—primarily by looking at the syntactic structure of previous human-based transformation and distilling them into patterns or rules to be applied going forward.

ML rules engine 1112 may send conversion instructions to conversion controller 1102.

Machine translation (EBMT) 1113 may receive training data from learning data repository and manager 1108.

Machine translation (EBMT) 1113 manages and recommends example-based machine transformations (EBMT). The models for these recommendations are computed from training data already in the system—using advanced machine learning techniques including, but not limited to, (deep) neural networks.

Machine translation (EBMT) 1113 may send conversion instructions to conversion controller 1102.

Leveled thesauri and dictionaries 1114 may receive training data from learning data repository and manager 1108.

Leveled thesauri and dictionaries 1114 manages and recommends language-based transformations, for example, from a thesaurus and/or dictionary.

Thesauri and dictionaries may be maintained at thesauri and dictionary data store 390, each thesaurus and/or dictionary containing minimal readability level data and/or minimal comprehensibility level data (for example, what is the lowest readability and/or comprehensibility level that would understand the terms therein) for every term they contain.

By this method, substitutions/additions can be recommended appropriate to the target readability and/or comprehensibility level of the content being converted. For example, the term “crimson” might be identified as a synonym of “red” at a minimum reading level of grade 10, and “red” is marked at grade 3 level. That is, that any user reading at grade 10 or above would be expected to be able to read “crimson”, while a substitution with the word “red” would be performed for a user closer to grade 3 level.

Substitutions or additions may be applied by looking for term matches in the original content with entries in the thesaurus/dictionary. If a term match found in the original content is determined to be at a different level than the target readability and/or comprehensibility level for that user, then synonyms/definitions may be identified that are more level-appropriate. Substitutions may be intended to introduce converted content that is either below the user's reading or comprehensibility level—or above their reading or comprehensibility level, but significantly closer to appropriate levels than the original term was. In many cases, leveled thesauri and dictionaries 1114 will create a list of possible substitutions for these identified terms—sorted by a combination of closeness to the target readability and/or comprehensibility level and the confidence values in those levels.

As thesauri and dictionaries data store 390 grows in size and accuracy, more and more accurate (to target readability and/or comprehensibility level) substitutions may be possible.

As with other data in content conversion system 100, synonyms and definitions may have a confidence level associated with their readability level and/or comprehensibility level designations, and those designations will evolve over time as new micro- and macro-input comes in.

In an example, leveled thesauri and dictionaries 1114 may analyze a thesaurus corpus, stored at thesauri and dictionaries data store 390, for terms and their word sense disambiguation. A readability level and/or comprehensibility level may be estimated, for example, based on frequency of occurrence, with certain confidences. Leveled thesauri and dictionaries 1114 may continually revise thesauri and dictionaries data store 390 on the basis of feedback received from content conversion system 100.

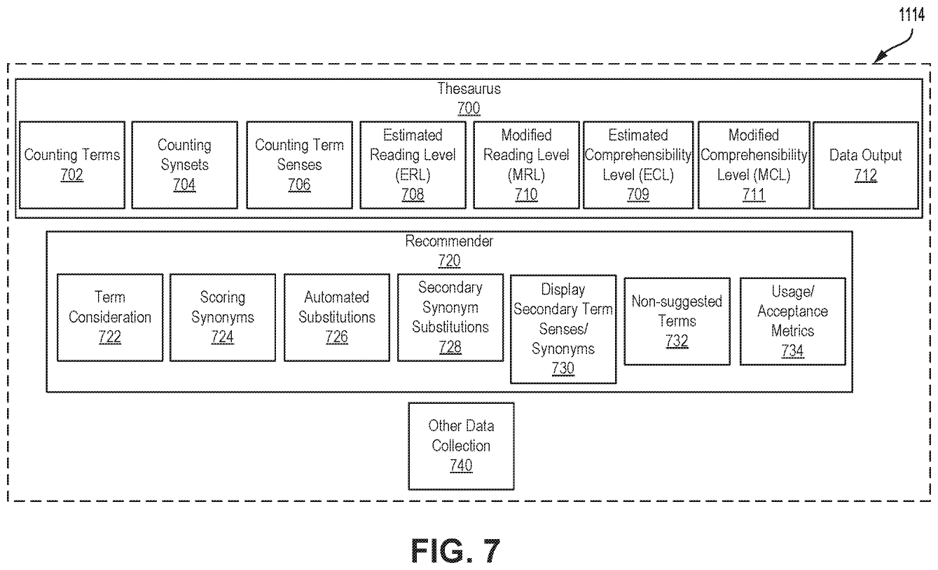

Configurations of leveled thesauri and dictionaries 1114, according to embodiments, are described in further detail below with reference to FIG. 7.

In some embodiments, software and storage related to leveled thesauri and dictionaries 1114 and/or thesauri and dictionaries data store 390 may be implemented in software, hardware or a combination thereof separate and distinct (in whole or in part) from content conversion system 100. In some embodiments, leveled thesauri and dictionaries 1114 may thus access data from content conversion system 100 by way of a suitable application programming interface (API).

Leveled thesauri and dictionaries 1114 may send conversion instructions to conversion controller 1102.

Semantic processing tools 1115 may receive training data from learning data repository and manager 1108.

Semantic processing tools 1115 manages and recommends semantic (meaning-based) transformations. This may include recommendations that fit more along the lines of “corrections” to the original content as well as those that deal with scope, style, and voice of the content.

Semantic processing tools 1115 may send conversion instructions to conversion controller 1102.

Human-based processes 1120 may include a collection of subsystems making recommendations for content conversion. Each is based on direct human-based intelligence/interaction (as opposed to machine-based intelligence). These subsystems operate at widely variable levels of human skill and task sizes, as required by the types of recommendations they provide. Professionals 150 may interface with human-based processes 1120 to provide input and feedback to content conversion system 100.

Human-based processes 1120 may receive original or semi-transformed content segments (or entire documents) from conversion controller 1102, and output transformed content segments to conversion controller 1102 and syntax analysis and mark-up 1101.

As shown in FIG. 4, human-based processes 1120 may include annotator system 1121, micro-task controller 1122 and validation system 1123, each described in further detail below.

Further suitable human-based subsystems may also be included, and human-based techniques and operations may be added or removed to human-based processes 1120 as desired.

Annotator system 1121 may receive original content segments from conversion controller 1102. In an example, content segments can be document-length.

Annotator system 1121 may gather data from various user interfaces, for example, by individual annotators, in an example, professionals 150 such as Plain Language Experts (PLEs), to manually convert original completed documents into specified lower readability levels and/or comprehensibility levels.

Annotators can include PLEs, or a wider audience including editors, internal individuals at an organization, or an organization's customers who are learning to write more simply. Thus, a wide variety of individuals can provide training data for annotator system 1121.

Annotators can upload their documents into annotator system 1121 along with a target readability and/or comprehensibility level for conversion to—and annotator system 1121 will perform the tasks of making the appropriate transformations and conversions. Annotator system 1121 is designed for PLEs to indicate well-marked “before and after” content segments to facilitate the collection of high-quality training data.

Each individual change to a document may be tracked for training data purposes. This will include changes at the level of individual words/terms, to phrase- and sentence-level changes, all the way to paragraph-sized conversions. As well, changes like deletions and additions, as well as rearranging of content will be tracked for purposes of building automation models.

Annotator system 1121 may also take advantage of machine-based recommendations as well as user-set favorite transformations to automate some of the conversion for PLEs within the annotator system 1121 itself—however PLEs may still verify these automated transformations. However, the main purpose of the annotator system 1121 is to collect training data to be used in content conversion system 100.

Annotator system 1121 may output transformed content segments to syntax analysis and mark-up 1101.

Micro-task controller 1122 may receive original content segments (for example, short—sentence length at most) from conversion controller 1102.

Micro-task controller 1122 is available to conversion controller 1102 for sending individual troublesome content segments to human-based agents to get micro-transformations completed. The decision to send a content segment for transformation may be controlled by conversion controller 1102, and may be based, for example, on a confidence level.

Micro-task controller 1122 may use a micro-marketplace to outsource the processes to professionals 150. Professionals 150, as human agents, receive the target segment (with some pertinent context) and are asked to rewrite the specific segment at the desired target readability and/or comprehensibility level. They will then enter that data to the system.

A single segment may be sent to multiple agents to get multiple versions of the conversion to compile a best-of combination (to “wash-out” imperfections by individual agents) or to be able to supply a list of possible choices for the end users.

Micro-task controller 1122 is designed to work both in a real-time and batch-like mode. That is, when appropriate/available, agents will be asked to perform micro-transformations as the end user is waiting for other automations to occur to their indicated content. This will require some sophisticated timing mechanisms.

Each individual change to a segment may be tracked for training data purposes, as with other conversions.

Micro-task controller 1122 may output transformed content segments to conversion controller 1102 and syntax analysis and mark-up 1101.

Validation system 1123 may receive original content segments (for example, short—sentence length at most) from conversion controller 1102.

Validation system 1123 is available to conversion controller 1102 for sending individual content segments to human-based agents to get micro-validations completed. These segments will be ones with low confidence in the available transformations—and the validation system will be used to boost those confidences past the view-or-don't-view threshold.

Validation system 1123 may use a micro-marketplace to outsource the processes to professionals 150. Professionals 150, as human agents, will receive the target segment (with some containing context) and be asked to either validate a specific transformation or choose from a list of possible transformations. A single segment may be sent to multiple agents to get several different validations.

Each individual validation (or non-validation) of a segment may be tracked for training data purposes. The data collected here may be similar in nature to the data collected when user 110 makes a selection between possible transformations. The system front-loads a decision-making process to a paid workforce, which may ensure the speed and quality of results.

Validation system 1123 may output validated content segments to conversion controller 1102 and syntax analysis and mark-up 1101.

Content presenter and feedback gatherer 1103 may receive raw converted content from conversion controller 1102.

Content presenter and feedback gatherer 1103 takes the raw converted content and formats or reformats it, for example, as a formatted draft target document, in preparation for presentation to the end-user or customer, such as user 110. This presentation format may be connected to the format that was present in content acquisition 1100 or it may be a different, proprietary viewing format. Also, this format may include specific indications of which elements of the original content have been transformed and it may tie each transformed segment to its original text (to allow for more in-depth feedback from the end-user/customer).

Content presenter and feedback gatherer 1103 may generate and send a formatted draft target document to an end-user.

Content presenter and feedback gatherer 1103 may also receive end-user/customer profile data from end-user and customer profiling and requirements manager 1106.

Content presenter and feedback gatherer 1103 may be configured to give the end-user/customer, such as user 110, the opportunity to make judgments on whether the current state of conversion meets their requirements. User 110 can choose to comment on the state, change their overall requirements, and/or return the content for further conversion. Also, user 110 can provide more micro inputs on individual segments that have been converted—even to the point of changing the conversion details. If user 110 makes any direct changes to content, this information is fed into the learning data repository and manager 1108 which may improve the automation of the overall system.

Content presenter 1003 may output a formatted final target document, end-user/customer profile data, and individual training data elements to conversion controller 1102, final content delivery 1105, end-user and customer profiling and requirements manager 1106 and learning data repository and manager 1108.

In some embodiments, application embedder 1107 may receive a formatted final target document from content presenter and feedback gatherer 1103.

Application embedder 1107 may be configured to express transformations from within the other applications in which digital content is being created, edited, and curated.

Application embedder 1107 may be implemented “inline”, such that as a content creator is entering content into the application, style sheet software 345 indicates transformations to be made or considered, and may require a tight coupling to the host application's data-stream.

Application embedder 1107 may also be implemented as an “add-in”, such that a content creator chooses a point in the content creation process to review the content through an add-in to the application. Transformations are processed through some sort of sidebar or separate window, tightly tied to the original application to provide immediate re-integration in the content stream. This method may require a lower level of integration with the host application.

Style sheet software 345 can be integrated with a number of text-based applications, in some embodiments, even if that text is created through voice, by way of application embedder 1107. Examples of such application include, but are not limited to, word processors, database editors, chat applications, website management tools, blogging tools, document management tools, dictation software, and the like.

Final content delivery 1105 may receive a formatted final target document from content presenter and feedback gatherer 1103 or from application embedder 1107.

Final content delivery 1105 allows an end-user/customer, such as user 110, to acquire a copy of the final content for their external purposes. The delivery format may be determined by the input format from content acquisition 1100.

End-user and customer profiling and requirements manager 1106 may receive a formatted draft target and end-user/customer profile data from content presenter and feedback gatherer 1103.

End-user and customer profiling and requirements manager 1106 tracks the end-user/customer (such as user 110 or other users 170) interactions with content conversion system 100 to compile a detailed profile of individual skills/requirements for user 110—both to facilitate the conversion of the current content, and also may determine better how to convert future content for maximal readability and/or comprehensibility. In addition, multi-dimensional information about individual users can be fed back into learning data repository and manager 1108 to refine the levels of various data elements.

An end-user profile is typically seeded with presenting user 110 with a reading level and/or comprehensibility level test in order to get a starting point for their capabilities. Once a starting point is obtained, the user's interactions may be tracked with future converted content aimed at that level. As user 110 indicates through their explicit and implicit actions and choices which parts of converted content is (and is not) at the proper level for them, that information may be used to alter (up or down) their individual target readability and/or comprehensibility level. This may be an ongoing process, intended to evolve knowledge of user 110 over time.

In addition, interactions of user 110 may be tracked at a more granular level—at each dimension of simplification—in order to: compile the larger, combined general readability level and/or comprehensibility level measure; determine whether the user needs a dimensionally-customized approach to content conversion (for example, if the user has a reading level of grade 8 for vocabulary but only a grade 4 sentence structure ability), content conversion system 100 may override its dimension-leveling technology to provide a customized experience for that user; and in some cases, determined by algorithm, a user with many-leveled dimensions could be an indication that measuring tools for different dimensions need modification. That is, if a user is at a consistent readability level and/or comprehensibility level, but level trackers are not, that information may be fed back into the learning system to aid in properly setting dimension measures.

End-user and customer profiling and requirements manager 1106 may track interactions of user 110 or other users 170 to track “favourites” for a particular user, resulting, for example, in a particular transformation being set to be automatically performed for a particular user.

End-user and customer profiling and requirements manager 1106 may also track, over time, changes in reading capabilities of user 110 (either for better or worse).

Some of the user interactions that may be tracked include: choices made by user 110 when presented with a list of possible conversions for a particular content segment; length of time spent by user 110 on reading certain parts of the overall content and other time-tracking events; corrections to the conversions that user 110 might provide; requests by user 110 for micro-conversions of content that were not initially converted; general level of the content provided by user 110 for conversion in the first place; and example documents at a good readability and/or comprehensibility level for user 110 that user 110 has indicated (either implicitly and explicitly).

End-user and customer profiling and requirements manager 1106 may output a formatted final target document, end-user/customer profile data, and individual training data element levels to conversion controller 1102, content presenter and feedback gatherer 1103 and learning data repository and manager 1108.

Learning data repository and manager 1108 may receive human-based training inputs, end-user profile data, customer feedback, and external data from content presenter and feedback gatherer 1103, end-user and customer profiling and requirements manager 1106, syntax analysis and mark-up 1101, and external data repositories and partner data 1109.

Learning data repository and manager 1108 stores and manages training data collected by content conversion system 100. Minor modifications may be performed on the data stored therein, based on actions taken by human elements in the overall system—including PLEs, customers, end-users (such as user 110 or other users 170), and micro-task performers, among others.

In some embodiments, models are not built directly in learning data repository and manager 1108. Training data may be selectively fed out to various modeling and action techniques as needed. The timing of this “feeding” to modelers may also be controlled by learning data repository and manager 1108 through a variety of “change-delta” techniques—that balance the need for updated information with the computational load of complex modeling techniques.

As a central repository of training data collected by content conversion system 100, each piece of data may be stored at learning data store 398 by learning data repository and manager 1108 with its full/maximal amount of meta-data. Learning data repository and manager 1108 may be configured to determine which elements of each piece of training data are needed for each application of that training data—and feeds out only what is needed on a case-by-case basis.

Learning data repository and manager 1108 tracks confidence levels associated with each individual piece of training data collected. These confidence levels ([0 . . . 1]) may be modified by user interactions with content conversion system 100 over time. These confidence levels may be subsequently fed to the modeling techniques to weight the “value” of individual elements of training data to the models computed.

The management part of learning data repository and manager 1108 is also responsible for storing training data, which may be stored uniquely—for example, incoming new elements may not be stored unless they are not actually already in the database. This may be done through a combination of automated comparison and merging techniques. Learning data repository and manager 1108 is also responsible for determining possible gaps in the training data and, eventually, informing other subsystem (e.g., micro-task controller 1122) to gather human input to fill those gaps.

Learning data repository and manager 1108 may send training data and data for partners to external data repositories and partner data 1109, ML rules engine 1112, machine translation (EBMT) 1113, leveled thesauri and dictionaries 1114, and semantic processing tools 1115.

External data repositories and partner data 1109 may receive training data from learning data repository and manager 1108.

External data repositories and partner data 1109 may obtain training data that comes through external/partner sources, instead of through content conversion system 100 directly. This data primarily feeds processes in content conversion system 100, but occasionally (depending on partner agreements) some refinements made to the data may be fed back to partners' systems.

External data repositories and partner data 1109 may send training data for content conversion system 100 to learning data repository and manager 1108.

FIG. 5 is a block diagram of syntax analysis and mark-up 1101.

Syntax analysis and mark-up 1101 may receive input from content acquisition 1100 and output data to conversion controller 1102 and learning data and repository manager 1108.

Syntax analysis and mark-up 1101 processes human-based content and transformations to prepare the content for use in automated processes of content conversion system 100 and eventually in the training data repository of learning data store 398.

As shown in FIG. 5, syntax analysis and mark-up 1101 may include tokenizer 1201, part of speech (“POS”) tagger and treebank generator 1202, super-structure and meta-data generator 1203, syntactic anomaly identification and correction 1210, initial mapper (in-part and overall) 1211, readability measures 1212, and comprehensibility measures 1213, as described in more detail below.

Some of the subsystems may be combined in external analysis packages—or across multiple packages. Further suitable syntax analysis and mark-up subsystems may also be included.

Tokenizer 1201 may receive plain-text content 130 from content acquisition 1100.

Tokenizer 1201 takes un-analyzed text content 130 and identifies the ordered list of tokens (words, punctuation, etc.) that makes up that content. The way tokens are identified may be customized over time.

Tokenizer 1201 may output plain-text content 130 and a token list to POS tagger and treebank generator 1202.

POS tagger and treebank generator 1202 may receive plain-text content 130 and a token list from tokenizer 1201.

POS tagger and treebank generator 1202 takes an ordered list of tokens and identifies the appropriate part of speech of each token. As well, any morphology information on individual tokens is determined.

In addition, treebank structures are constructed for all content—including (but not limited to) constituency trees and dependency trees. So, after processing by this subsystem, each element of the content may be identified, along with where it fits in the general structure and a meaning involved.

POS tagger and treebank generator 1202 may output plain-text content, marked-up token list and treebanks to super-structure and meta-data generator 203.

Super-structure and meta-data generator 1203 may receive plain-text content, marked-up token lists and treebanks from POS tagger and treebank generator 1202.

Super-structure and meta-data generator 1203 determines further information about the current content that does not necessarily have a one-to-one correspondence to each token. For example, larger syntactic elements (sentences, clauses, phrases, etc.) are identified. Also, certain linguistic elements (e.g., lemmas, entities, sentiment, categorizations, etc.) that apply to only specific tokens or to larger subsets of tokens are identified and stored. In many respects, this new information is meta-data on the entire content.

Super-structure and meta-data generator 1203 may output plain-text content, marked-up token lists, treebanks and meta-data to syntactic anomaly identification and correction 1210.

In some embodiments, super-structure and meta-data generator 1203 may output plain-text content, marked-up token lists, treebanks and meta-data to conversion controller 1102, for example, for transformations on the basis of style sheet software 345.

Syntactic anomaly identification and correction 1210 may receive marked-up original content from super-structure and meta-data generator 1203.

Syntactic anomaly identification and correction 1210 analyzes the syntactic structure of the marked-up content to identify possible syntactic errors in the original content—errors that are not involved with simplification of the content. These possible errors are marked in the content for later presentation to the end-user (and, perhaps, validation). If a discovered error has a high-confidence correction, the correction is made to the content before passing it on to the next subsystem. (However, the made corrections are marked as such and can be reverted later in the overall process.)

Syntactic anomaly identification and correction 1210 may output marked-up content with potential syntactic corrections identified to initial mapper 1211.

Initial mapper 1211 may receive content such as marked-up content with potential syntactic corrections identified from syntactic anomaly identification and correction 1210, readability measures 1212, and comprehensibility measures 1213.

Initial mapper 1211 analyzes base readability level(s) of content such as the user content, for example, received from readability measures 1212, and saves this information to the overall data structure, which can occur before any transformation or simplification is performed. To map the readability level(s) on the content, a variety of industry standard tools and formulae are used, including (but not limited to) the Flesch-Kincaid, Coleman-Liau, and Gunning Fog, or other suitable readability tests.

Initial mapper 1211 also analyzes base comprehensibility level(s) of content such as the user content, for example, received from comprehensibility measures 1213, and saves this information to the overall data structure, which can occur before any transformation or simplification is performed.

In some embodiments, content conversion system 100 may generate other comprehension measures and indices which may be used to analyze new material (recognizing the risk of “over-fitting”). Such comprehension measures may be provided as a SaaS-based offering separate from the main content conversion system 100.

Depending on the length of the original content, readability measures generated by readability measures 1212 and comprehensibility measures generated by comprehensibility measures 1213 may be applied on contiguous subsets of the content—for example, at the paragraph and sentence levels.

Initial mapper 1211 may output pre-analyzed content, including readability levels and comprehensibility levels, to conversion controller 1102, learning data repository and manager 1108, readability measures 1212 and comprehensibility measures 1213.

Readability measures 1212 may receive marked-up content with potential syntactic corrections identified from initial mapper 1211.

Readability measures 1212 evaluates readability measures of identified segments of content and returns the readability level(s) information computed. To compute the readability level(s) on the content, a variety of industry standard tools and formulae are used, including (but not limited to) the Flesch-Kincaid, Coleman-Liau, and Gunning Fog, or other suitable readability tests.

In an example, the Flesch Reading Ease measure can be implemented with the following formula:

$$206 \text{.} 835 - 1 \text{.} 015 * \frac{\text{total words}}{\text{total sentences}} - 84.6 * \frac{\text{total syllables}}{\text{total words}} \qquad ( 1 )$$

A Flesch Reading Ease score of 90-100 can indicate content readable by a fifth grader, while Flesch Reading Ease scores between 0-30 indicate readability by college graduates.

Similarly, the Flesch-Kincaid Grade Level measure recasts the score to map to a value that corresponds with a US grade level:

$$.39 * \frac{\text{total words}}{\text{total sentences}} + 11 .8 * \frac{\text{total syllables}}{\text{total words}} - 15.59 \qquad ( 2 )$$

In formula (2), the resulting value represents the minimum grade level a reader of the content would require.

Formulas (1) and (2) both rely on the variables: average words per sentence and average syllables per word.

Other readability measures, which can use more and more complex variables include: Dale-Chall, Gunning fog, McLaughlin's smog, FORCAST, and other suitable measures.

Readability measures 1212 may output readability level data to initial mapper 1211.

Comprehensibility measures 1213 may receive marked-up content with potential syntactic corrections identified from initial mapper 1211.

Comprehensibility measures 1213 evaluates comprehensibility measures of identified segments of content and returns the comprehensibility level(s) information computed.

To compute the comprehensibility level(s), sometimes referred to as a content comprehensibility measure (CCM) herein, on content, a number of factors can be measured and represented by values such as real variables. Factors contributing to a comprehensibility level can include a clause/phrase density (CPD), a content word density (CWD), a whitespace ratio (WSR), an average coreference distance (ACD), a coreference density (CRD), a heading density (HD) and other variables such as average dependency tree depth/sentence, average constituency tree depth/sentence, subject matter clustering, passive voice density, clausal break density, subject/verb/object combinations/sentence, average complexity of content words, and the like.

Each factor may be quantified such that a lower value corresponds to less comprehensible content in that factor or dimension and a higher value corresponds to more comprehensibility of the content (with the exception of average coreference distance, described in further detail below). Values determined by factors may be restricted to a bounded range between zero and one. Cases where values are returned outside of the range between zero and one may be changed to 0 or 1, accordingly. Thus, a consistent bounded overall formula for a comprehensibility level may be constructed.

Each factor can be assigned expected values that represent high, medium, and low levels of comprehensibility. These values can be chosen by using expert linguistic input and also by cross-measuring against a set of pre-graded (for comprehensibility) samples.

Clause/phrase density (CPD) is a factor to evaluate the number of clauses and phrases per sentence, as an increase in clauses and phrases per sentence may increase difficulty in comprehending content. Certain clause types, when combined within a single sentence, can decrease comprehensibility more than other clause types do. Clausal density can be defined as:

$$CPD = \frac{\text{number of sentences}}{( \begin{matrix}\text{independent clauses} + 0.5 * \\ \text{dependent clauses} + 0.25 * \\ \text{prepositional phrases}\end{matrix} )} \qquad ( 3 )$$

High, medium, and low levels of comprehensibility may be associated with the following CPD values:

Low Comprehensibility: CPD=0.4

Medium Comprehensibility: CPD=0.55

High Comprehensibility: CPD=0.75

Content word density (CWD) is a factor to evaluate the ratio of content words to simpler words, as the higher the ratio of content (i.e., possibly complex) words to simpler words, the less comprehensible the overall content may be. Content words can be defined by what they are not, including: proper nouns (NNP), jargon words, stopwords (e.g., the, a, it, by, . . . ), and high-frequency common words. Content word density can be defined as:

CWD=1−(content_words)/(total_words) (4)

High, medium, and low levels of comprehensibility may be associated with the following CWD values:

Low Comprehensibility: CWD=0.25

Medium Comprehensibility: CWD=0.5

High Comprehensibility: CWD=0.75

Whitespace ratio (WSR) is a factor to evaluate the ratio of “whitespace” characters in content, as the higher the ratio of “whitespace” in a content, the more comprehensible the content may be. Whitespace characters can include line-breaks, paragraph-breaks, page-breaks, bullet points, and numbers and letters in enumerated lists. Whitespace ratio can be defined as:

WSR=(whitespace characters)/(total characters) (5)

Each whitespace character may be given equal weight (such as a value of one), or different weight.

High, medium, and low levels of comprehensibility may be associated with the following WSR values:

Low Comprehensibility: WSR=0.03

Medium Comprehensibility: WSR=0.1

High Comprehensibility: WSR=0.15

Average coreference distance (ACD) is a factor to evaluate the average distance between coreferences. Coreference is when a pronoun (he, she, they, it, which, etc.), referred to as an antecedent, refers back to a noun, referred to as the anaphor, that defines it. The distance can be defined as the least number of words between the antecedent and its anaphor.

In an example, the sentence “While he wasn't sure about the mathematics, Fred agreed with the idea, anyways.”, “he” is an antecedent whose anaphor is “Fred,” and the distance between them is six words.

Distance can be measured completely within a sentence or counted across sentences.

Average coreference distance can be defined as:

$$ACD = \frac{\text{number of antecedent/anaphor pairs}}{sum ( \text{distance per antecedent/anaphor pair} )} \qquad ( 6 )$$

In some embodiments, formula (6) can be modified to take into account antecedents without (or with ambiguous) anaphors in the given content.

Coreference density (CRD) is a factor to evaluate the frequency of coreferences. Coreference is when a pronoun (he, she, they, it, which, etc.), referred to as an antecedent, refers back to a noun, referred to as the anaphor, that defines it. For example, in the sentence: “While he wasn't sure about the mathematics, Fred agreed with the idea, anyways.”, “he” is an antecedent whose anaphor is “Fred.”

The more coreferences there are in a piece of content, the less comprehensible the content may be. Coreference density can be defined as:

CRD=(number of coreferences)/(number of sentences) (7)

In some embodiments, formula (7) can be modified to take into account antecedents without (or with ambiguous) anaphors in the given content.

Heading density (HD) is a factor to evaluate the number of headings and subheadings present in content, as the higher the number of headings and subheadings in content, the more comprehensible the content may be. Heading density can be defined as:

HD=(total headings)/(total sentences) (8)

Each heading type may be given equal weight (such as a value of one), or different weight.

Each variable or value determined for the above factors may be assigned a relative weight factor, based at least in part on the importance or relevance of the variable to overall comprehensibility.

Each variable's weight can be assigned values chosen by using expert linguistic input and also by cross-measuring against a set of pre-graded (for comprehensibility) samples.

In an example, the following relative weights can be assigned to variables: Clause/Phrase Density (CPD): Relative weight=6; Content Word Density (CWD): Relative weight=4; and Whitespace Ratio (WSR): Relative weight=3. Thus, CPD, CWD and WSR would each contribute 6/13, 4/13, and 3/13 of the overall comprehensibility value, respectively.

Comprehensibility measures 1213 may evaluate content for one or more of the above factors to determine a comprehensibility level of the content.

A comprehensibility level can be quantified using a number of different techniques. The comprehensibility level values described herein are real number values, however, other output values are also contemplated.

In an example, a comprehensibility level is constructed to return a value that typically falls between zero and ten. The value of zero can be interpreted as low comprehensibility (or very complex) and the value of ten can be interpreted as high comprehensibility (or very understandable). In some embodiments, the value of zero may be interpreted as the lowest possible comprehensibility, and the value of ten may be interpreted as the highest possible comprehensibility.

In some embodiments, a comprehensibility measure will always return values between zero and ten. In some embodiments, it will be possible to construct content samples that return values less than zero or greater than ten—but that content will be outliers.

Using the following relative weightings: CPD relative weight=6, CWD relative weight=4, and WSR relative weight=3 applied to the following expected medium comprehensibility values: CPD=0.55, CWD=0.5, and WSR=0.1, results in the following weighted value for CPD:

$$CPD weighted expected value = variable weight * expected medium comprehensibility value = 6 * 0.55 = 3.3 \qquad ( 9 )$$

The expected value of CPD at medium comprehensibility is thus 3.3

CWD has an expected medium comprehensibility value of 0.5, and contributes a relative weight of 4*0.55=2.2 in the above scenario. Thus, a constant of 4.4 can be used for an adjusted relative weight.

WSR has an expected medium comprehensibility value of 0.1, and contributes a relative weight of 3*0.55=1.65 in the above scenario. Thus, a constant of 16.5 can be used for an adjusted relative weight.

Combining the adjust relative weights determined above, a comprehensibility level (“CCM_medium”) can be defined as:

CCM_{medium}=6*CPD+4.4*CWD+16.5*WSR (10)

Formula (10) returns, at the expected medium values:

$$CCM\_medium = 6 * 0.55 + 4.4 * .5 + 16.5 * 0.1 = 3.3 + 2.2 + 1.65 = 7.15 \qquad ( 11 )$$

Formula (10) applied to expected high comprehensibility values returns a comprehensibility level (“CCM_high”):

$$CCM\_high = 6 * CPD\_high + 4.4 * CWD\_high + 16.5 * WSR\_high = 6 * 0.75 + 4.4 * 0.85 + 16.5 * 0.15 = 4.5 + 3.74 + 2.4 \; 75 = 10.715 \qquad ( 12 )$$

Formula (10) applied to expected low comprehensibility values returns a comprehensibility level (“CCM_low”):

$$CCM\_low = 6 * CPD\_low + 4.4 * CWD\_low + 16.5 * WSR\_low = 6 * 0.4 + 4.4 * 0.25 + 16.5 * 0.3 = 2.4 + 1.1 + 0.4 \; 95 = 3.9 \; 95 \qquad ( 13 )$$

The combination of the expected values from formulas (12), (11), and (13) can be represented as follows:

[low,medium,high]→[3.995,8.511,10.715] (14)

To restrict formula (14) to a range between zero and ten, the expected values can be normalized. For example, the expected values can be restricted to a difference between a typical high comprehensibility input and a low comprehensibility input to be approximately eight points, reflecting scores of about nine and one, respectively.

With a difference in expected values is 10.715-3.995=6.72 all variable constants can be divided by 6.72/8˜=0.84, resulting in a revised formula for comprehensibility measure (“CCM”):

CCM=7.14*CPD+5.24*CWD+19.64*WSR (15)

Formula (15) generates revised expected values of:

[low,medium,high]→[4.7552,8.511,12.755] (16)

Formula (16) results in a desired difference of approximately eight.

To fit formula (16) between a high comprehensibility value of approximately nine and a low comprehensibility value of approximately one, the values can be shifted by subtracting from a constant value, such as 3.755:

CCM=7.14*CPD+5.24*CWD+19.64*WSR˜3.755 (17)

Formula (17) generates revised expected values of:

[low,medium,high]→[1,5.72,9] (18)

Formula (17) thus provides an example formula using three variables and providing values within the desired range and interpretation.

Formula (17) is an example illustration of one method to derive a desired measure for content comprehensibility. The formula can be adjusted to account for a different range and/or interpretation.

Using the general approach demonstrated above, a process, for example, implemented by content conversion system 100 on a computing device, can automatically compute appropriate constants based at least in part on elements such as: variables to be included in the formula, expected values (at high/medium/low comprehensibility levels, or even at a finer grain), variable weights, target range, and target interpretation.

The elements identified above can change based on circumstances such as: further testing of human-rated exemplar content against the output of the automated formula, further testing of appropriate expected values and their possible gradations, addition of further variables into the formula, and the like.

Comprehensibility measures 1212 may output comprehensibility level data to initial mapper 1211.

FIG. 6 is a block diagram of conversion controller 1102, according to an embodiment.

Conversion controller 1102 takes the analyzed initial content 130 supplied, for example, by user 110 and controls the process by which that content is transformed, for example, into equivalent (or as close to equivalent as possible) content at a lower readability or comprehensibility level. In some embodiments, transformation of content 130 may be on the basis of stylistic guidelines. As shown in FIG. 6, conversion controller 1102 may receive input such as content 130 from syntax analysis and mark-up 1101.

An ordered variety of methods and processes may be employed to perform transformation, combining machine-based and human-based methods. The ordering of these methods may be set specifically to maximize the overall effect on the entire document or body of text.

Transformations may also be performed in a nested manner, with changes within changes.

In general, consideration of each individual transformation performed may be based on whether the individual transformation falls within reasonable bounds of the target readability level and/or target comprehensibility level for the overall transformation, and the confidence the subsystem has in that transformation. The confidence of a particular transformation may be based on a scale [0 . . . 1].

In some embodiments, if the confidence is too low, a specific transformation is not even considered. If the confidence is high enough, the transformation may be made automatically. When confidence falls somewhere in-between these extremes, then human discernment may be used to make a go/no-go decision, and the discernment may then feed back into the confidence levels.

Conversion controller 1102 may perform transformations based on one or more dimensions. In an example, a “semantic” dimension may define a semantic analysis of the meaning of the text. Likewise, a “syntactic” dimension may define a syntactic analysis of the structure of the text.

In some embodiments, dimensions may be defined with further particularity, and each dimension is transformed independently. For example, syntactic analysis may include operations performed by dimensions of syntactic structure substitution 1302, and reference/dependency substitution 1303, described below. Semantic analysis may include operations performed by dimensions of voice substitution 1309, tense/aspect substitution 1310, and vocabulary substitution and definition insertion 1311, as described below.

Conversion to a target readability level, target comprehensibility level, or style may be performed on the basis of each dimension independently. Conversion controller 1102 may also try to keep the confidence level for each dimension even across the entire document of text.

Conversion controller 1102 may segment content into pieces, convert as necessary, and then recombine, which may ensure that the target readability level and/or target comprehensibility level achieves the target both in-whole and in-part.

As shown in FIG. 6, conversion controller 1102 may include content partitioner 1300, machine translation substitution 1301, syntactic structure substitution 1302, reference/dependency substitution 1303, voice substitution 1309, tense/aspect substitution 1310, vocabulary substitution and definition insertion 1311, semantic analysis and adjustment 1312, content recombination 1330, overall level analysis and gatekeeper 1331, as described in more detail below. Other suitable techniques may be contemplated for transforming content.

Content partitioner 1300 may receive pre-analyzed content (completely or in part), including readability levels, comprehensibility levels, and partially transformed content from syntax analysis and mark-up 1101 and overall analysis and gatekeeper 1331.

Content partitioner 1300 takes pre-analyzed text content and splits it into contiguous subsets of content, the size of which depends on which process(es) the content is to be passed through for transformation. For example, if the content is to go through annotator system 1121, it is passed as one, whole segment (fundamentally by-passing the partitioning). Alternatively, if the content is to have auto-transformation applied, it may be broken into segments representing the maximal extent of contained reference/dependency. This maximal dependency can be set at a reasonable level (e.g., paragraph) or can be computed interactively by dependency tree information supplied with the content.

Content may be partitioned to ensure that the transformation is done evenly. That is, that all parts of the content may be transformed as evenly as possible to the target readability and/or comprehensibility level. As well, partitioning may allow for easier assignment of human-based micro-inputs.

Content partitioner 1300 may output content partitions to annotator system 1121 and machine translation substitution 1301.

Machine translation substitution 1301 may receive a segment of completely pre-analyzed content, possibly partially pre-transformed from micro-task controller 1122 and content partitioner 1300.

Machine translation substitution 1301 takes a segment of pre-analyzed text content and applies machine translation techniques to it to determine whether the current models support any transformations to the content. These models may be computed from time to time from training data within the larger system, using various MT techniques, including (but not limited to) example-based machine translation (EBMT).

When a clear go/no-go decision cannot be made for a specific transformation (or set of transformations) being considered, machine translation substitution 1301 may send the decision out for human-based micro-input(s), such as micro-task controller 1122.

Machine translation substitution 1301 may output a segment of completely pre-analyzed content, possibly further transformed to micro-task controller 1122 and syntactic structure substitution 1302.

Syntactic structure substitution 1302 may receive a segment of completely pre-analyzed content, possibly partially pre-transformed from micro-task controller 1122 and machine translation substitution 1301.

Syntactic structure substitution 1302 takes a segment of pre-analyzed text content and applies syntactic transformation techniques to it, changing the sentence structure of the content to a more-readable readability level and/or comprehensibility level. These transformations may be “hand-coded” from industry best practices and/or computed from pattern-based machine learning models which are recomputed from available training data from time to time.

When a clear go/no-go decision cannot be made for a specific transformation (or set of transformations) being considered, the subsystem may send the decision out for human-based micro-input(s), such as micro-task controller 1122.

In an example, syntactic structure substitution 1302 may perform a grammatical change to convert a segment bifurcated by a semi-colon into two separate sentences separated by a period. In another example, detected semi-colons content may be converted to a bullet point list.

Syntactic structure substitution 1302 may output a segment of completely pre-analyzed content, possibly further transformed, to micro-task controller 1122 and reference/dependency substitution 1303.

Reference/dependency substitution 1303 may receive a segment of completely pre-analyzed content, possibly partially pre-transformed, from micro-task controller 1122 and syntactic structure substitution 1302.

Reference/dependency substitution 1303 takes a segment of pre-analyzed text content and applies reference/dependency transformation techniques to it, replacing obtuse and difficult references within the content with explicit details to create a more-readable readability level and/or comprehensibility level. These transformations may be “hand-coded” from industry best practices and/or computed from algorithmic processes.

When a clear go/no-go decision cannot be made for a specific transformation (or set of transformations) being considered, the subsystem may send the decision out for human-based micro-input(s), such as micro-task controller 1122.

Reference/dependency substitution 1303 may output a segment of completely pre-analyzed content, possibly further transformed to micro-task controller 1122 and voice substitution 1309.

Voice substitution 1309 may receive a segment of completely pre-analyzed content, possibly partially pre-transformed, from micro-task controller 1122 and reference/dependency substitution 1303.

Voice substitution 1309 takes a segment of pre-analyzed text content and applies voice (e.g., active vs. passive tense) transformation techniques to it, replacing difficult voice usages within the content with simpler voice usages to create a more-readable readability level and/or comprehensibility level. These transformations may be “hand-coded” from industry best practices and/or computed from algorithmic processes.

These substitutions may be applied broadly across an individual document to maintain as much of a consistent voice usage as is required by the content.

When a clear go/no-go decision cannot be made for a specific transformation (or set of transformations) being considered, the subsystem may send the decision out for human-based micro-input(s), such as micro-task controller 1122.

Voice substitution 1309 may output a segment of completely pre-analyzed content, possibly further transformed, to micro-task controller 1122 and tense/aspect substitution 1310.

Tense/aspect substitution 1310 may receive a segment of completely pre-analyzed content, possibly partially pre-transformed from micro-task controller 1122 and voice substitution 1309.

Tense/aspect substitution 1310 takes a segment of pre-analyzed text content and applies tense/aspect verb transformation techniques to it, replacing difficult verb usages within the content with simpler verb usages to create a more-readable readability level and/or comprehensibility level. These transformations may be “hand-coded” from industry best practices and/or computed from algorithmic processes.

These types of substitutions may be applied broadly across an individual document to maintain as much of a consistent verb usage as is required by the content.

When a clear go/no-go decision cannot be made for a specific transformation (or set of transformations) being considered, the subsystem may send the decision out for human-based micro-input(s), such as micro-task controller 1122.

Tense/aspect substitution 1310 may output a segment of completely pre-analyzed content, possibly further transformed to micro-task controller 1122 and vocabulary substitution and definition insertion 1311.

Vocabulary substitution and definition insertion 1311 may receive a segment of completely pre-analyzed content, possibly partially pre-transformed from micro-task controller 1122 and tense/aspect substitution 1310.

Vocabulary substitution and definition insertion 1311 takes a segment of pre-analyzed text content and applies vocabulary transformation techniques to it, replacing difficult term usages within the content with simpler term usages to create a more-readable readability level and/or comprehensibility level. When a simple synonym-based substitution is not applicable, vocabulary substitution and definition insertion 1311 also has the option to leave the original term in place but define the term in question within the document somehow (e.g., footnotes, pull-outs, in-line, etc.). These transformations may be “hand-coded” from industry best practices and/or computed from algorithmic processes. As well, they may rely upon “leveled thesauri or dictionaries” created within the system.

These types of substitutions may be applied broadly across an individual document to maintain as much of a consistent term usage as is required by the content.

When a clear go/no-go decision cannot be made for a specific transformation (or set of transformations) being considered, the subsystem may send the decision out for human-based micro-input(s), such as micro-task controller 1122.

In an example, vocabulary substitution and definition insertion 1311 may replace a word such as “factors” with the word “things”. In another example, the word “gather” may be replaced with the word “collect”.

Vocabulary substitution and definition insertion 1311 may output a segment of completely pre-analyzed content, possibly further transformed, to micro-task controller 1122 and semantic analysis and adjustment 1312.

Semantic analysis and adjustment 1312 may receive a segment of completely pre-analyzed content, possibly partially pre-transformed from micro-task controller 1122 and vocabulary substitution and definition insertion 1311.

Semantic analysis and adjustment 1312 takes a segment of pre-analyzed text content and applies semantic analysis techniques to it, to better understand the meaning of the transformed content. It compares this semantic analysis against a semantic analysis of the original content and determines whether any semantic adjustments are required to bring the meanings of original and transformed content back inline.

When a clear go/no-go decision cannot be made for a specific adjustment (or set of adjustments) being considered, the subsystem may send the decision out for human-based micro-input(s), such as micro-task controller 1122.

Semantic analysis and adjustment 1312 may output a segment of completely pre-analyzed content, possibly further transformed, to micro-task controller 1122 and content recombination 1330.

Content recombination 1330 may receive a segment of completely pre-analyzed content, possibly partially pre-transformed, from semantic analysis and adjustment 1312.

Content recombination 1330 takes a segment of content that was partitioned by the content partitioner 1300 and then transformed through various processes and recombines it into an ever-growing replica of the original document. As segments come through the larger transformation process, the segments are added back into the new document, but memory of their individual extents is also recorded.

Content recombination 1330 may output an ordered collection of transformed segments to overall level analysis and gatekeeper 1331.

Overall level analysis and gatekeeper 1331 may receive an ordered collection of transformed segments from end-user profiling and requirements manager 1106, annotator system 1121, readability measures 1212, comprehensibility measures 1213 and content recombination 1330.

Overall level analysis and gatekeeper 1331 takes an ordered collection of segments (or a complete document) that were transformed through various processes and determines its/their current readability and/or comprehensibility level. The readability and/or comprehensibility level can be measured using readability measures 1212 and comprehensibility measures 1213, as described herein, and, in some embodiments, by internal measurement developed over time. Thus, overall level analysis and gatekeeper 1331 may determine an estimate of progress towards a target readability and/or comprehensibility level on the basis of the characteristics of transformations that have been performed.

Taking this measurement may ensure that the entire original document is being transformed to the target readability and/or comprehensibility level at a consistent rate across the document. That is, that one section of the document is not meaningfully simpler/more complex than any other.

Also, taking this measurement may ensure that the document is simplified evenly across “dimensions”—which may, for example, ensure that document does not result in a simple syntactical structure but complex vocabulary (or vice versa).

If it is determined that an individual segment or set of contiguous segments has strayed too far from the target readability and/or comprehensibility level (in any dimension of simplicity) then those segments in question can be passed back through content partitioner 1300 for further transformation (and, perhaps, re-partitioning).

Once overall level analysis and gatekeeper 1311 receives all the original documents transformed segments and determines that the entire transformed document is within allowed tolerances of the target readability and/or comprehensibility level, the transformed document is passed to content presenter and feedback gatherer 1103.

Overall level analysis and gatekeeper 1311 may output a segment of completely pre-analyzed content, possibly further transformed, to content presenter and feedback gatherer 1103 and content partitioner 1300.

FIG. 7 is a block diagram of leveled thesauri and dictionaries 1114, according to an embodiment.

Typical thesauri may simply give a list of the synonyms in a synset, without any indication to the calling application (or writer/editor) as to which terms are at which levels of complexity. Therefore, the application user must self-assess all information about the required complexity. Implementation of leveled thesauri and dictionaries 1114 may allow for a prioritized list of terms to be presented dependent upon a target readability and/or comprehensibility level.

Typical previously-existing dictionaries may have only one definition for each word sense. This definition itself may be written at a level of complexity beyond the reach of certain readers, rendering the information in it useless. Leveled thesauri and dictionaries 1114 may allow for multiple definitions at varying readability and comprehensibility levels for each word sense.

Typical previously-existing thesauri/dictionaries did not interactively evolve with new usage and familiarity metrics—that is, they do not accurately reflect when terms/concepts become more mainstream or less mainstream over time. Leveled thesauri and dictionaries 1114 may track usage and familiarity and adjust behavior accordingly.

Thus, leveled thesauri and dictionaries 1114 may provide a reading-level and/or comprehensibility-level synchronized thesaurus and dictionary. In some embodiments, a thesaurus and dictionary may be synchronized on the basis of other paradigms, such as language translation, disability software, regional dialect translation, and the like.

Leveled thesauri and dictionaries 1114 may be configured to provide readability level and comprehensibility level information to all synonyms (and antonyms, hypernyms, etc.) and definitions for all terms/concepts within the thesauri/dictionaries, for example, stored at thesauri and dictionaries data store 390. These reading/comprehensibility levels may be used to help identify complexity and pick optimal related terms or definitions for any term/concept and can be used within any digital application that requires readability/comprehensibility-appropriate content.

In some embodiments, standard synsets (for a set of synonyms attached to a specific word sense; for example, the synset for trail(noun) might be {path, track, aisle, pathway, road, route, stream, . . . }) are instantiated within the invention, containing thorough sets of concepts and their relations. Beyond synonyms, relationships such as hypernyms (a concept that contains the term, for example, “color” is a hypernym of “red”), hyponyms (a concept that is contained by the term, for example, “crimson” is a hyponym of “red”), and the like, may be included.

Each synonym in each synset may contain a numerical indicator of reading-level and/or comprehensibility-level of that synonym within the context of the synset. These values are initially estimated from available data. Synsets may also contain multiple definitions, each definition also having a reading-level and/or comprehensibility-level value.

Through operation of calling applications (e.g., content conversion system 100) connected to the data, changes to the reading-level and/or comprehensibility-level values within the synsets may be made automatically, which may improve the accuracy of the values.

Readability and/or comprehensibility level values for each synonym in a synset may revised from initial estimates by (at least) the following processes:
The addition of new/more data that updates the factors on which the initial estimates were computed. For example, by analyzing more corpora and thereby getting more accurate frequency counts, then that can revise a readability and/or comprehensibility level.
Improved processes for analyzing corpora (for example, word sense disambiguation), which could also affect the base values on which estimates are computed.
The addition (post-estimate) of completely new data elements that are incorporated into formulas for the readability/comprehensibility levels.

Readability/comprehensibility level values may also be revised based on user/human feedback mechanisms including (but not limited to):
User verification (or de-verification) of system suggestions for term substitution based on the current readability/comprehensibility level values. For example, if the user switches an automated suggestion in favour of another synonym, then the readability/comprehensibility level value for the suggested and the switched synonyms might change. There are many other examples of this sort.
Human-based validation of readability/comprehensibility levels. This could happen through an explicit synonym by synonym process put in place for more important concepts. Or, this could come from “graded” reading lists received from publishers and other sources.
Analysis of well-leveled source documents and the terms within them, in order to get more accurate readability/comprehensibility levels in the thesaurus.

In some embodiments, a method of integrating large external datasets in areas such as new terms, or new values (e.g., frequency of usage) may be used to compute and modify reading-level or comprehensibility-level values.

Leveled thesauri and dictionaries 1114 may be implemented in document editing software, document writing software, or predictive text suggestion software. The modified data (evolving over time) may be used as part of a reading-level or comprehensibility-level measurement system for documents.

In some embodiments, leveled thesauri and dictionaries 1114 may distinguish synonyms/definitions of concepts on dimensions other than reading-level or comprehensibility-level. This could open usage to whole suits of products including language translation, disability software, regional dialect translation, and the like.

In some embodiments, leveled thesauri and dictionaries 1114 may utilize web-based crawlers and partnerships with dictionary/thesaurus companies to update new terms in the lexicon in thesauri and dictionaries stored in thesauri and dictionaries data store 390.

As shown in FIG. 7, leveled thesauri and dictionaries 1114 may include a thesaurus 700, a recommender 720 and other data collection 740, as described in more detail below.

In collecting and analysing data that is word sense disambiguated (WSD), thesaurus 700 is configured to collect and analyse terms within a thesaurus, and includes counting terms 702, counting synsets 704, counting term senses 706, estimated reading level (ERL) 708, modified reading level (MRL) 710, estimated comprehensibility level (ECL) 709, modified comprehensibility level (MCL) 711, and data output 712. Recommender 720 is configured to make term substitution recommendations, for example, through annotator system 1121, and includes term consideration 722, scorings synonyms 724, automated substitutions 726, secondary synonym substitutions 728, display secondary term senses/synonyms 730, non-suggested terms 732 and usage/acceptance metrics 734. Finally, other data collection 740 may collect other data about user choices.

Counting terms 702 collects term and sense frequency data from within various sets of sample documents/texts. This data may be used primarily to determine how “common” a term is within a specified sense and, thereby, its estimated reading level and/or comprehensibility level.

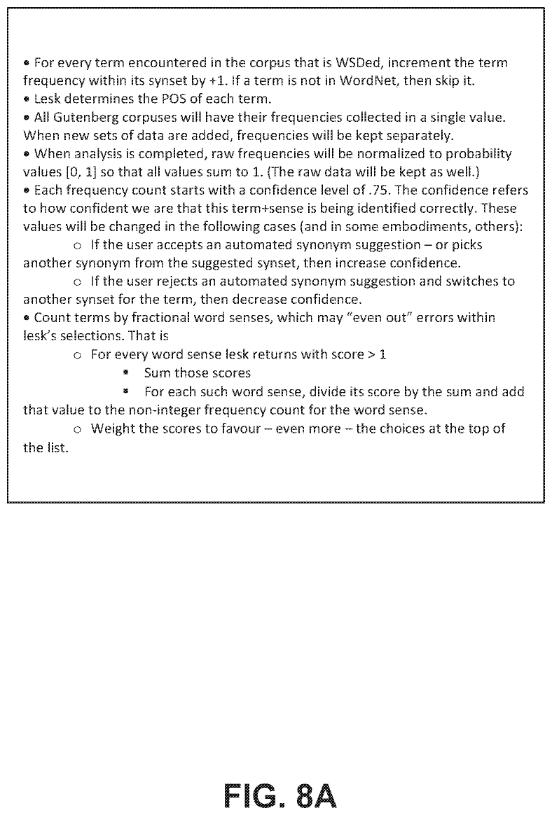

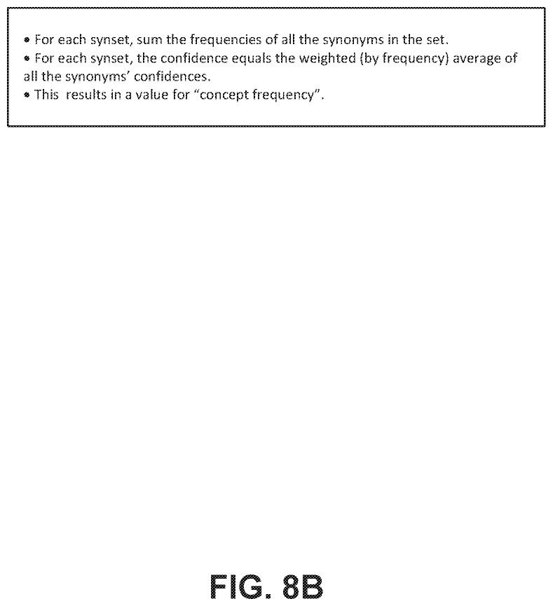

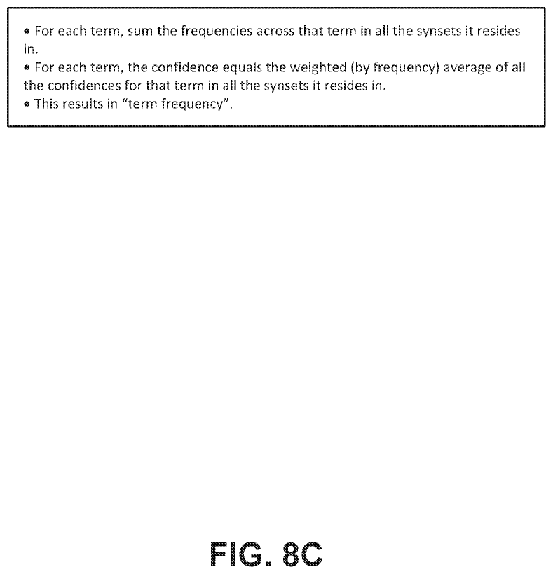

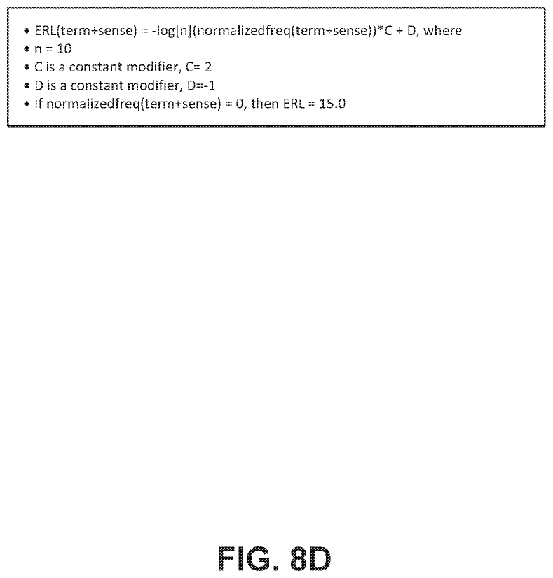

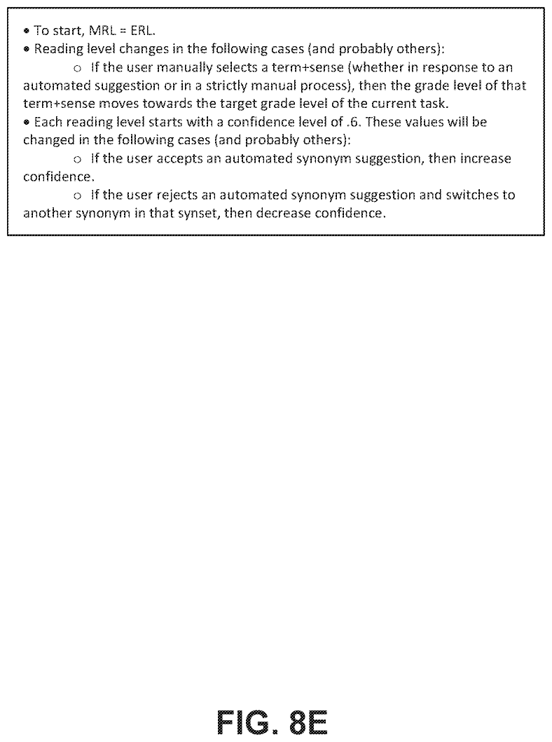

FIG. 8A lists pseudo-code for one possible implementation for counting terms 702.

Counting synsets 704 determines the total frequency of all the synonyms within a single sense, for example, the total frequency for all the synonyms of “trail” as “a track or mark left by something that has passed”. This would represent, in some respects, the “Commonness” of the concept involved.

FIG. 8B lists pseudo-code for one possible implementation for counting synsets 704.

Counting term senses 706 determines the total frequency of all the term senses for a single term, for example, the total frequency for all the senses of “trail”. This would represent, in some respects, the “Commonness” of the term involved.

FIG. 8C lists pseudo-code for one possible implementation for counting term senses 706.

Estimated reading level (ERL) 708 creates an initial estimate for a reading level for terms and senses.

FIG. 8D lists pseudo-code for one possible implementation for estimated reading level (ERL) 708.

Once an ERL is established, modified reading level (MRL) 710 modifies the ERL value based on further learning and data acquired.

FIG. 8E lists pseudo-code for one possible implementation for modified reading level (MRL) 710.

Estimated comprehensibility level (ECL) 709 creates an initial estimate for a comprehensibility level for terms and senses, which can be based at least in part on frequency of terms, frequency of synonyms within a single sense, and frequency of term senses.

Once an ECL is established, modified comprehensibility level (MCL) 711 modifies the ECL value based on further learning and data acquired, for example, based at least in part on manual selection by a user of a term and sense, and whether a user accepts or rejects an automated synonym suggestion.

Data output 712 may output, for example in a comma-separated values (“csv”) file, terms and senses (even those with 0 frequency) with the following elements: term, synset (sense), definition, raw frequency, normalized frequency, term frequency, concept frequency, ERL, MRL, ECL, and MCL.

Turning now to recommender 720, term consideration 722 determines whether a term should be considered for substitution. It may be desirable to limit the number of substitutions made at one time in a task so that the result is not too overwhelming to the reader/editor. In some embodiments, substitutions are selected that would make the most difference in lowering the overall document readability level, comprehensibility level or score.

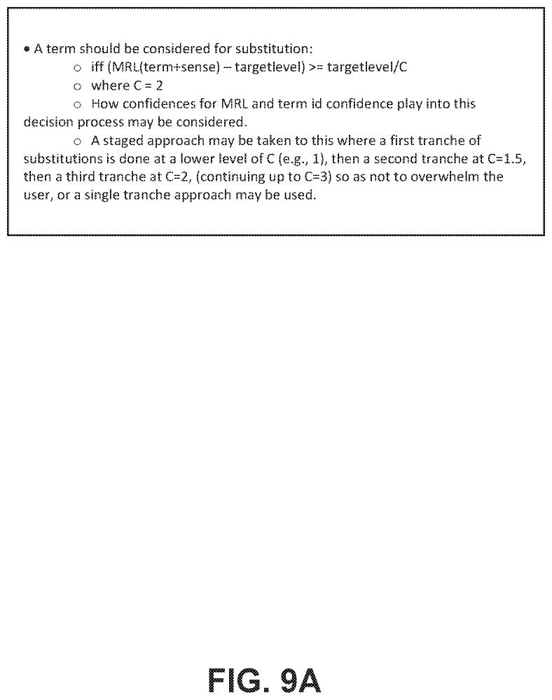

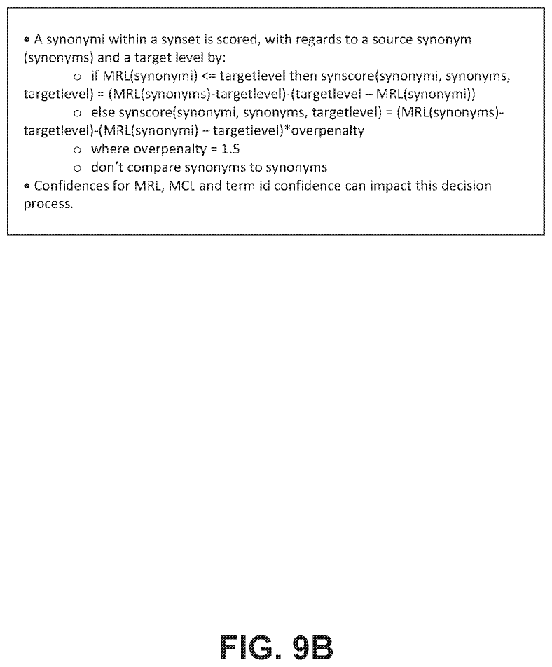

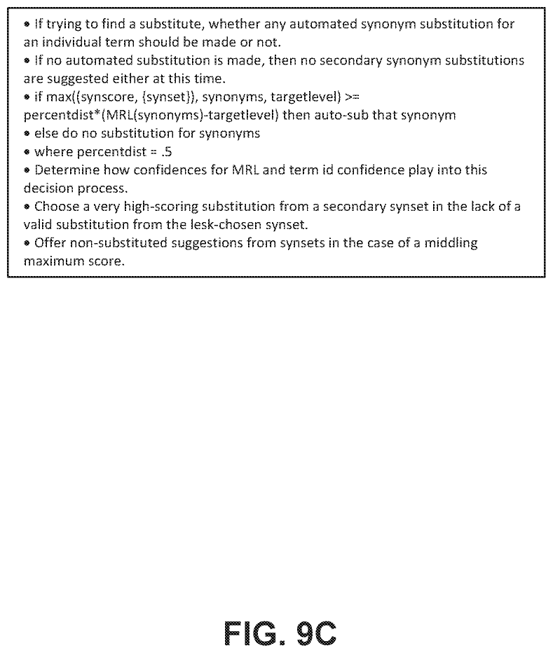

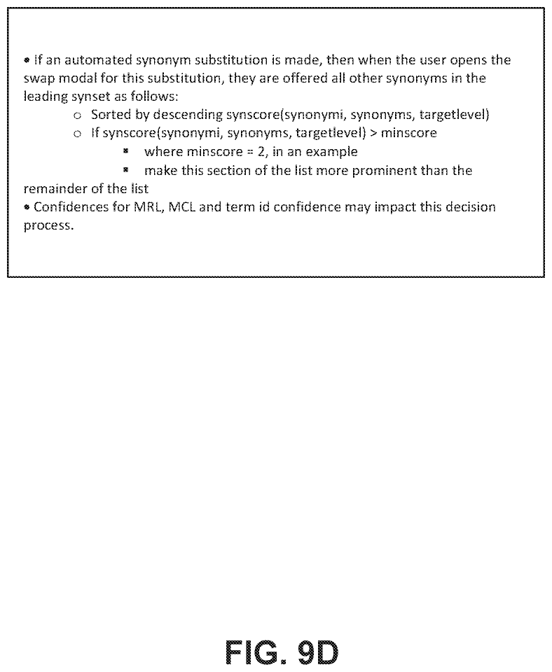

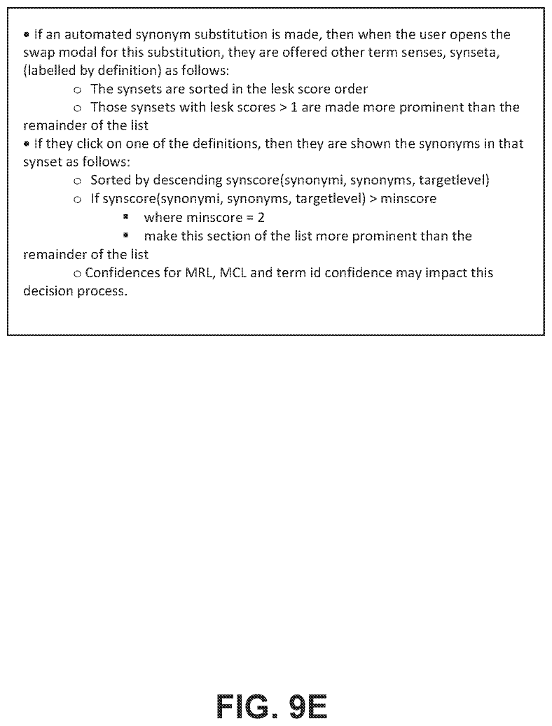

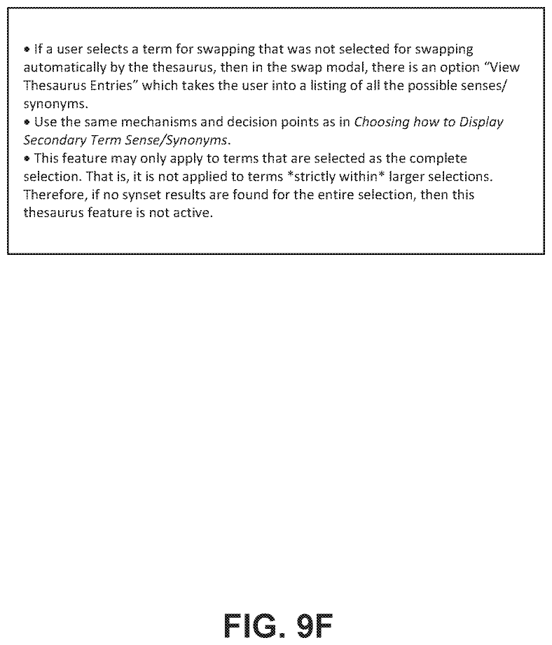

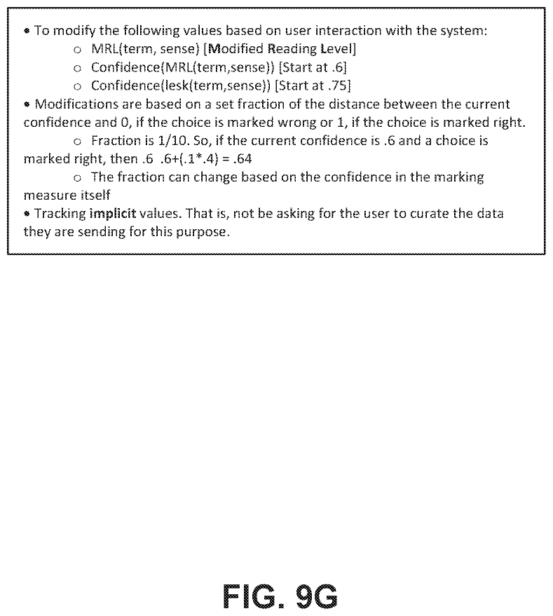

FIG. 9A lists pseudo-code for one possible implementation for term consideration 722. Term consideration 722 may also determine whether a term should be considered for substitution on the basis of comprehensibility and may be implemented based on a modified comprehensibility level in a similar manner to modified readability level.

Scoring synonyms 724 scores each synonym based on the target readability level and/or target comprehensibility level for the task, which may allow for the most reading-level appropriate synonym(s) to be picked. Synonyms may be similarly scored based on target comprehensibility level, which may allow for the most comprehensibility-level appropriate synonym(s) to be picked.

FIG. 9B lists pseudo-code for one possible implementation for scoring synonyms 724. Scoring synonyms 724 may score synonyms based on a modified comprehensibility level in a similar manner.

Automated substitutions 726 determines a threshold for whether auto-substitutions of a term should be attempted.

FIG. 9C lists pseudo-code for one possible implementation for automated substitutions 726. Automated substitutions 726 may determine thresholds based on a modified comprehensibility level in a similar manner.

Secondary synonym substitutions 728 determines how to offer secondary synonym substitutions.

FIG. 9D lists pseudo-code for one possible implementation for secondary synonym substitutions 728.

Display secondary term senses/synonyms 730 determines how to display secondary term senses/synonyms.

FIG. 9E lists pseudo-code for one possible implementation for display secondary term senses/synonyms 730.

Non-suggested terms 732 determines how non-suggested terms may be selected.

FIG. 9F lists pseudo-code for one possible implementation for non-suggested terms 732.

Usage/acceptance metrics 734 tracks usage/acceptance metrics and modifying values.

FIG. 9G lists pseudo-code for one possible implementation for usage/acceptance metrics 734. Usage/acceptance metrics 734 may track usage/acceptance metrics and modifying values based on a modified comprehensibility level in a similar manner.

Other data about user choices may also be collected, by other data collection 740, which may inform algorithmic choices, including:
FreqSuggested(term,sense)—How often was this term+sense auto-suggested?
FreqAccepted(term,sense)—How many of those suggestions were kept?
FreqReverted(term,sense)—How many of those suggestions were reverted?
FreqChanged(term,sense)—How many of those suggestions were changed for another suggestions from a list?
FreqEdited(term,sense)—How many of those suggestions were manually replaced with a new term?
FreqChosen—How often was the term+sense chosen in a user-driven scenario?
Also track confidence in lesk correctly identifying the term+sense

Returning to FIG. 3, style sheet software 345 may manage style sheets stored in style sheet data store 392. As such, style sheet software 345 may provide a methodology for organizing, managing and applying knowledge of a corporation, by application of stylistic guidelines and instantiating organization stylistic decisions.

Traditional techniques can include individuals in an organization who are responsible for the quality and consistency of content that the organization creates. Such individuals typically have a list of guidelines and rules on such issues as proper vocabulary, simplification, grammar usage, and formatting.

A challenge with such guidelines is adherence and application, which may not be accurately and consistently applied in content creation and curation.

Conveniently, systems and methods for style guide automation, as disclosed herein, for example, including style sheet software 345, may provide a structure whereby stylistic rules, embodied as style sheets, can be instantiated and then automatically applied to documents being created. In some embodiments, instantiation and application may occur within content creation applications such as MS Word, Google Docs, HTML editors, and the like. In some embodiments, control may be implemented as “executive function”, or as the creativity of individual content creators.

Style sheet software 345 may communicate with machine-based processes 1110 to control or prioritize transformations of conversion controller 1102, thus imposing both limitations and overrides in the way of positive actions (enforcing certain actions to occur during a transformation, as dictated for example by a style sheet), and negative actions (preventing certain actions from occurring during a transformation, as dictated for example by a style sheet).

Existing methods for creating, curating, and managing stylistic guidelines within corporations may be inefficient, unstructured, and prone to error. Also, these guidelines may be only sporadically followed, partly because of the inaccessible format in which the guidelines are stored. In addition, the format and technology (or lack thereof) behind these guidelines may make them difficult to update and evolve over time as language and internal preferences change.

Style sheet software 345 may overcome these problems by providing a well-structured, well-managed, auto-applied technology for style guidelines and corporate dictionary data. After the existent style information is ingested, the user can make corrections and modifications to the data to ensure they continue to meet company standards. Thereafter, style sheet software 345 automatically determines, by analysis of corporate content introduced to the system, where and how these guidelines should be applied. Users may have the choice to revert a stylistic change if they feel it is not appropriate within a specific context.

Style sheet software 345 may also present an easy-to-use user interface that allows administrators to view, edit and otherwise manage the data within their instantiated guidelines. In addition, stylistic changes made by individual users of the technology can be “promoted” by administrators to a place in the corporate guidelines when appropriate, thus easily supporting the evolution of these guidelines over time. As well, style sheet software 345 may prompt administrator to add guidelines for stylistic elements that are in common use in the industry but may be missing from their data.

In some embodiments, style sheet software 345 may provide a method for an administrator (acting for an entity) to have the power to enforce suggestion of certain transformations seen (as changes made by the system) by an entire group of individual users under their purview. The administrator can make these determinations on any types of changes that the system can make—sometimes on a term-by-term basis (e.g., straight word substitution or semicolon syntax changes) or, alternatively, on a more broad-brush basis (e.g., turning on/off vocabulary substitution and definition insertion 1311 or machine translation substitution 1301).

Conveniently, style sheet software 345 may avoid a need for spending large amounts of resources to maintain current stylistic guidelines that are not effectively used within organizations.

Style sheet software 345 may thus provide mechanisms for curation (new stylistic decisions are easier to discover, instantiate, and auto-populate within content), consistency (stylistic guidelines are applied largely automatically in content, ensuring consistent usage across the enterprise), accessibility (the stylistic data may be readily-accessible within a designed UI so that it is easy to read, to understand, to modify, and to update), and portability (the stylistic guidelines can be applied automatically to content in a variety of formats (e.g., Word, Excel, Write, etc.) by the addition of plug-ins for those applications).

Applications of style sheet software 345 may revolve around adding more and more types of stylistic guidelines (e.g., based on font usage, text color, heading choices, etc.).

For example, style sheet software 345 may apply style sheets across one or more of a variety of different paradigms, including corporate policy or “corporate speak”, dialects, or other decision-making metrics.

In some embodiments, any transformation made to a document within content conversion system 100 may be added to a style sheet.

In some embodiments, a style sheet may restrict recommendations that may be made for transformation, for example, by excluding machine learning recommendations in such a way that may provide a more deterministic result.

In some embodiments, software and storage related to style sheet software 345 and/or style sheet data store 392 may be implemented in software, hardware or a combination thereof separate and distinct (in whole or in part) from content conversion system 100.

In an example, style sheets stored at style sheet data store 392 may include a subset of transformation favourites based on a corporate policy. In some embodiments, style sheets may operate as a favourite management system.

Style sheets may be defined as parameters of how a system such as content conversion system 100 operates or performs transformations. A style sheet may include transformation techniques to be followed or omitted. A style sheet may be associated with a corporation, for example, and a particular corporate policy.

In an example, a style sheet may include rows of decisions to be made in transformation of text, such as replacing instances of a semi-colon with a period, performing certain word replacement, and identifying certain transformations that are not to be performed.

In some embodiments, style sheet software 345 ingests existing style sheet and corporate dictionary data from clients. The data is then integrated into applications (such as content conversion system 100 or MS Word) that leverage the data to make automated and semi-automated changes to existing content and processes, in order to make that content conform to the styles sheets and corporate dictionaries. Also, style sheet software 345 may allow for the efficient access to this data by the clients for purposes of understanding the data, modifying the data and updating the data according to instantiated best practices.

In some embodiments, user lists stored at style sheet data store 392 may include information relating to permissions and a hierarchy of users. A user level may be associated with a level of control over stylistic changes and how transformations are or are not implemented.

For example, administrator user levels may occupy the top of a hierarchy, associated with administrator users who are in charge of setting stylistic decisions, and may be the last line of editing to corporate content. Administrators may be responsible for making and maintaining stylistic decisions, instantiating those decisions as “elements” or transformations within the product, dealing with any exceptions to following these guidelines by lower-level users, policing non-conformance to the guidelines, and other suitable tasks.

In some embodiments, multiple levels of administration can be supported.

The user list can also designate lower-level users, associated with end-users of style sheet software 345. End-users may be users producing content in an organization, and could be in marketing, sales, technology, or any other internal department. End-users may be responsible for creating content, reacting to/following stylistic transformations made by the product, raising objection to specific transformations, when appropriate, and suggesting new rules for the organization, either explicitly or implicitly.

In some embodiments, multiple levels of end-users can be supported. For example, the head of a marketing communications department might have higher-level control than the individual marketing employees in that department.

The user list may define the hierarchy in which suggestions and data flows upstream through users, while rules flow downstream through users.

Style sheet software 345 may include an importer/exporter 3410, transformation manager 3420 and dashboard analytics 3430.

Importer/exporter 3410 can be configured to import stylistic guidelines in standard static formats (e.g., Word, Excel, txt) and instantiates the stylistic guidelines within style sheet data store 392 and export data in style sheet data store 392 to standard static formats (e.g., Word, Excel, txt, and the like).

Transformation manager 3420 can be configured to implement a management UI that allows administrators to review, organize, and modify stylistic data within style sheet data store 392, include mechanisms for automatically instantiating ingested/created stylistic guidelines into target content documents; and a include mechanism for taking user stylistic decisions and promoting them to company-wide stylistic guidelines.

As illustrated in FIG. 4, in some embodiments, style sheet software 345, such as transformation manager 3420, is in communication with machine-based processes 1110. Style sheet software 345 can operate as a controller, and thus provide limitations and overrides (for example, as defined in a style sheet) to machine-based processes 1110, and its various components, for execution of transformations by conversion controller 1102. In some embodiments, certain transformations are prioritized by style sheet software 345.

In some embodiments, style sheet software 345 may pass through machine-based processes 1110 (for example, a null set of machine-based processes 1110), and conversion controller 1102 can perform replacements as indicated in a style sheet.

Transformation manager 3420 may be configured to collect actions, suggestions and objections made by users, collated from the lowest-level users up through the higher levels of users, as defined in a user list.

In an example, the collected data of users in Department A will be used to inform the product for Department A. The data of all departments will be collected to the administration level and help inform the product for the entire organization. (There may also be separate levels of departmental hierarchy as well.)

By way of transformation manager 3420, admins at any level can create stylistic rules, embodied as style sheets, that effect all levels below them. Sometimes these decisions will come as reaction to data flowing upstream, but other times the rules will be created by the administrator independently.

Thus, when style sheet software 345 encounters an element of content that can be transformed, guidance on the nature of that transformation comes from the highest level, as defined in the user list, first. If there is no guidance, then the next-lower level (in the path of that user) will be checked on for guidance, and so on down to the level of the individual user's own department level.

Transformation manager 3420 can also include an interface, for example, a formalized interface or dashboard, to allow administrators to manage the contents and usage of the stylistic rules, such as those that an administrator creates.

The interface can include, an importing style information feature to allow administrators to ingest their pre-existing stylistic guidelines data (if any) into style sheet software 345 using importer/exporter 3410. This importing feature can support standard formats such as MS Excel, MS Word, Google Docs, and the like. If there are any elements of the pre-existing data that cannot be automatically converted into data elements within the application, a wizard-like process will help step the administrators through the importing details.

The interface can also include an editing feature that allows administrators to edit existing stylistic rules and/or add new ones to the system (post-bulk-imports).

Transformation manager 3420 can perform a full suite of stylistic decisions and transformations, including (but not limited to): vocabulary transformations, grammatical transformations, sentence/paragraph/section/document length transformations, textual formatting (e.g., use of bullet point), structural formatting (e.g., headers, pull-outs, etc.), layout formatting (e.g., whitespace use, font use), and the like.

Transformation manager 3420 can make explicit content transformations. In a host application, by way of application embedder 1107, explicit changes can be made to the content—one item is substituted for another. These transformations can be marked so that the content creator knows that they have been made and can challenge the application of the specific rule, if necessary.

Interactions with the transformation can be tracked by dashboard analytics 3430 for future analysis.

Transformation manager 3420 can generate suggested transformations, for example, if a specific transformation has been identified, but there is not adequate confidence in the transformation to perform said transformation. In these cases, transformation manager 3420 may mark the relevant content and provide a suggestion for change to the content creator. The content creator can choose whether to apply the transformation or some revision of the suggestion. A weighted score of a confidence of a transformation may be based on the number of instances of a received transformation, the number of times a transformation has been rejected, and/or a number of times a transformation has been accepted.

Transformation manager 3420 can also generate guidance transformations, as something identified in the content that requires thought by the content creator, but style sheet software 345 has no specific recommendations for transformations to make. For example, “when you see XXXXX, you might want to consider YYYYYY.”

Transformation manager 3420 can further generate negative transformations, in particular, the ability to specify when not to perform a transformation. Transformation manager 3420 can identify what terms or usages in the source content should not be recommended for transformation—primarily because they have been marked as proper, desired usage. In some embodiments, negative transformations are created in response to the style sheet software 345 attempting (for other reasons/rules) to transform an item that should not be touched. Negative transformations are also able to be created manually from scratch.

Interactions with transformations generated by transformation manager 3420 can be tracked by dashboard analytics 3430 for future analysis.

In some embodiments, when content is transformed by style sheet software 345, a user can indicate that they do not agree with a given transformation, and style sheet software 345 thus receives user feedback such as a “challenge”. A “challenge” can be implemented by way of transformation manager 3420 to select a relevant transformation and select a challenge option, which provides the end-user the ability to include reasoning why they feel the transformation is inappropriate.

A challenge can have ramifications such as the following: the individual transformation to which the challenge is attached is reverted to its original state in the relevant content; a notification of the challenge is sent to each admin in the chain to the top of the admin organization; a “challenge count” for that particular transformation is incremented by one—admins can review these counts and, for any transformation, review the meta-data (end user, reasoning, etc.) for that challenge; in the admin panel, the challenge is displayed until it is dealt with, for example, by determining that the original transformation is correct—which gets communicated to the originating end-user, determining that the original transformation is incorrect in this case—which gets communicated to the originating end-user, or determining that the original transformation is incorrect in all cases—which then gets instantiated in modified rules.

The interface can further interact with a tracking feature of dashboard analytics 3430 to track how many times each stylistic rule has been applied to source content. This tracking feature can also provide meta-data about how many times a stylistic transformation was accepted, rejected, challenged, or edited for analysis by dashboard analytics 3430. This information will help administrators to manage the stylistic rules to suit current usage and to resolve any issues that might arise in the use of these rules.

In some embodiments, this tracking feature will be connected to the “ad hoc” transformations that end-users make using the system, so that commonly used transformations can be identified and possibly promoted into stylistic rules going forward.

Dashboard analytics 3430 can, over time, collect and build knowledge about best-practice stylistic rules/usages by analyzing data from multiple customers. This can allow the product to make recommendations for stylistic rules/usages to individual customers. Some of those recommendations will be vertical-specific (for example, in the insurance sector), while others will be more general and able to be applied cross-vertical.

To create these recommendations, dashboard analytics 3430 can analyze existing stylistic guidelines and transformation use for all customers with respect to their identified verticals. Alternately, recommendations (either vertical-specific or cross-vertical) might be created by independent (i.e., non-customer-based) research into best practices. Any recommendations made for a specific customer will be presented as either vertical-specific or cross-vertical.

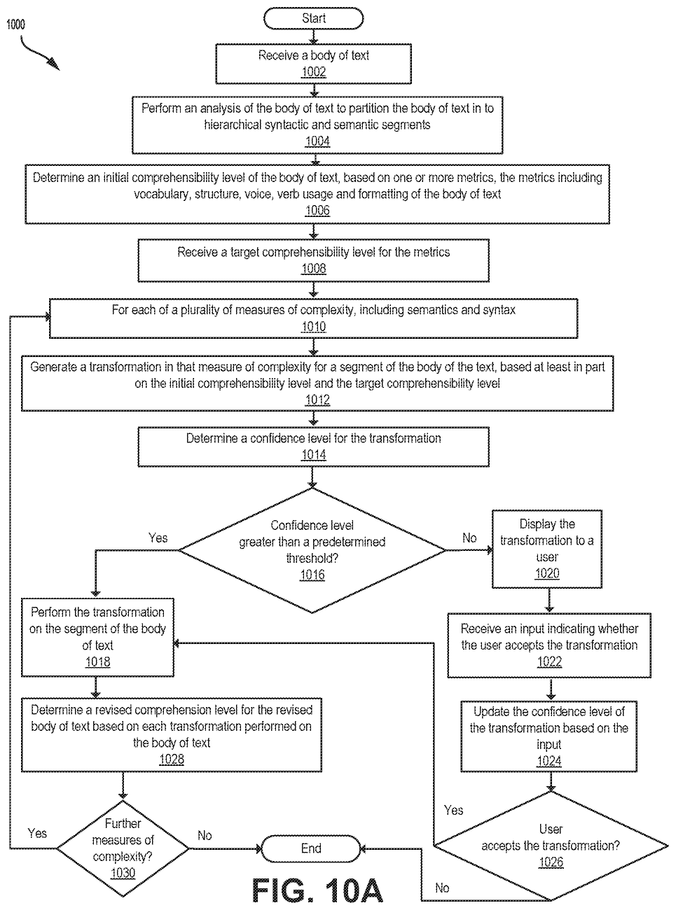

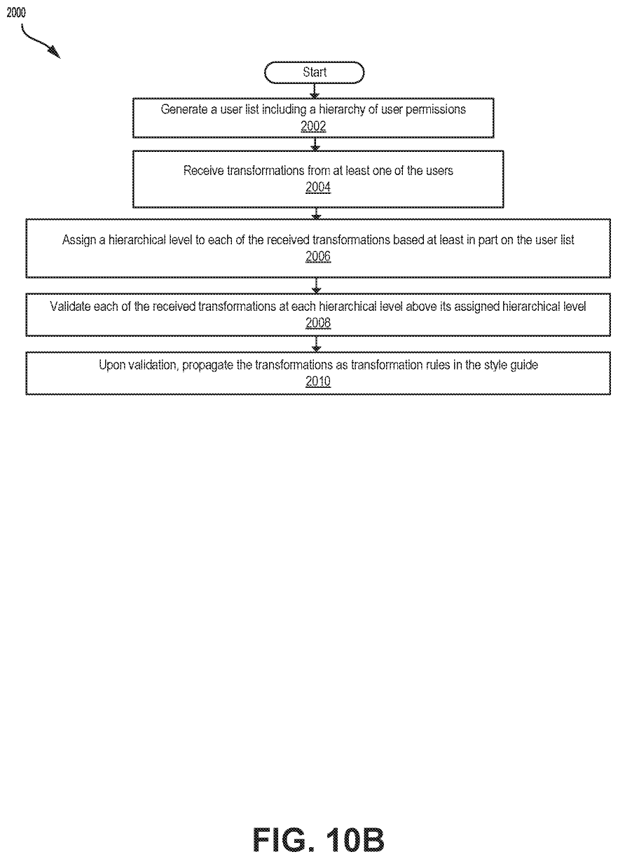

The operation of a method 1000 of content conversion is described with reference to the flowchart of FIG. 10A, in accordance with an embodiment. Blocks 1002 onwards are performed by processors(s) 210 executing software at content conversion system 100. It should be understood that the blocks may be performed in a different sequence or in an interleaved or iterative manner.

At block 1002, a body of text is received.

At block 1004, processors(s) 210 perform an analysis of the body of text to partition the body of text in to hierarchical syntactic and semantic segments.

At block 1006, processors(s) 210 determine an initial comprehensibility level of the body of text, based on one or more metrics, the metrics including, but not limited to, vocabulary, structure, voice, verb usage and formatting of the body of text.

At block 1008, a target comprehensibility level for the metrics is received.

At block 1010, control flow proceeds to block 1012 for each of a plurality of measures of complexity, including semantics and syntax.

At block 1012, processors(s) 210 generate a transformation in that measure of complexity for a segment of the body of the text, based at least in part on the initial comprehensibility level and the target comprehensibility level.

At block 1014, processor(s) 210 determine a confidence level for the transformation.

At block 1016, processor(s) 210 evaluate if the confidence level greater than a predetermined threshold. If yes, control flow continues to block 1018. If no, control flow continues to block 1020.

At block 1020, the transformation is displayed to a user.

At block 1022, an input is received indicating whether the user accepts the transformation.

At block 1024, the confidence level of the transformation is updated based on the input.

At block 1026, processor(s) 210 evaluate whether the user accepted the transformation. If no, the method ends. If yes, control flow proceeds to block 1018.

At block 1018, processor(s) 210 perform the transformation on the segment of the body of text to generate a revised body of text.

At block 1028, processor(s) 210 determine a revised comprehensibility level for the revised body of text based on each transformation performed on the body of text.

At block 1030, processor(s) 210 evaluate whether there are further measures of complexity, or dimensions, to consider. If yes, control flow returns to block 1010. If no, the method ends.

The operation of a method 2000 of style guide automation to generate a style sheet is described with reference to the flowchart of FIG. 10B, in accordance with an embodiment. Blocks 2002 onwards are performed by processors(s) 210 executing software at content conversion system 100. It should be understood that the blocks may be performed in a different sequence or in an interleaved or iterative manner.

At block 2002, processors(s) 210 generates a user list, including a hierarchy of user permissions associated with users.

At block 2004, processors(s) 210 receive transformations from at least one of the users.

At block 2006, processors(s) 210 assign a hierarchical level to each of the received transformations based at least in part on the user list.

At block 2008, processors(s) 210 validate each of the received transformations at each hierarchical level above its assigned hierarchical level.

At block 2010, upon validation, processor(s) 210 propagate the transformations as transformation rules in the style guide.

In some embodiments, a body of text is received and processor(s) 210 perform the transformations of the style sheet on the body of text.

Applications of systems described herein, including content conversion system 100, include embedding into web browsers such that a webpage can be converted to a different reading level, training chat bots to modulate their language based on with whom they are speaking, and integration with speech technologies (e.g., speech assistants, speech-to-text, audio information, text-to-speech, etc.), amongst other applications.

Users, such as user 110 and other users 170 may include consumers, such as everyday people who are trying to decipher the world around them. For example users may include parents, older adults, seniors, low-literate adults, young adults, those with intellectual disabilities/cognitive challenges, English-Language Learners, highly-educated adults, and the like.

Users may also include businesses, for use with internal applications for information being disseminated within the organization, such as healthcare organizations, financial institutions, banks, insurance companies, and the like. Use may be for regulation and compliance purposes and/or inter-department communication between different business units.

External applications for businesses include for information being disseminated outside the organization, such as schools, healthcare organizations, financial institutions (i.e. banks, insurance companies), and the like.

Users may also include tech companies developing their own natural language processing technology, such as companies with chatbots, and the like.

Users may also include government or public service entities, for legislation, regulations, rules, government websites, Public Service Announcements, health & safety notices, and the like.

To illustrate the application of a senior consumer as a user, the following example is provided. In this example, Suzanne is 74 years old. She immigrated to Canada as a child, has no education beyond early elementary school grades, and used to work in a Campbell's soup factory. Suzanne has found it difficult to make sense of information as she ages. In the last 5 years it has been increasingly challenging to make sense of the information her low-income housing unit has provided her about changes in rent and community by-laws.

Luckily, Suzanne has content conversion system 100 on her home speech device. When Suzanne gets a notice from the building manager she is able to voice activate the speech device and says: “help me understand this letter. It says: [she reads the notice].” And then her in home speech device will re-read the document in clearer language and define key terms saying things like “what residential tenancy means is . . . ”. Suzanne is so grateful to have this technology readily accessible in her home through speech prompts, especially given her only daughter lives across the country in a different time zone and is often asleep when Suzanne is trying to decipher this information in a timely fashion.

To illustrate the application of a highly educated lawyer as a user, the following example is provided. In this example, Malcolm is a highly educated lawyer who studied at Princeton. He also did research on constitutional law during his law school years, but ended up working in tax reform for the last decade. He has become a sought-after expert for many cases beyond his own workload. As a result, the volume of documents he needs to read are quite significant.

Luckily, Malcolm has content conversion system 100 on his laptop. He is able to click the “swap it” button in his word processor (i.e. Microsoft Word™) and PDF reader (i.e. Adobe™). When he clicks this button, the current text of the document on the screen is replaced with much easier to read language. Because it requires much less brain-power to grasp what the documents are actually saying, Malcolm has more mental energy and strength to process the implications of the clauses. He is able to process 30% more documents per week than he used to.

To illustrate the application of a parent as a user, the following example is provided. In this example, Leanne is a new mom in her mid-twenties. She is married and has decided to take maternity leave once she has her new baby boy next week while her wife works as a business operations manager. Leanne is a paralegal by training and has found the medical language used to explain her pregnancy and forthcoming delivery very overwhelming. While she and her wife, Mary, have taken to the internet to search some of the terms in the documents their OB-GYN and family doctor provided, they only found equally as confusing reports online. They were also unsure of the veracity of the claims online so wanted to focus on the information from the pamphlets and on the hospital's website. Being confronted with terms like preeclampsia and effacement has only added to their nervousness with their first child.

Luckily Leanne recently downloaded content conversion system 100 on her mobile device. The app integrates right into the operating system so that she never has to open it again. Anytime she is in her email or web app searching information and key terms she heard at the doctor's office she is able to press a semi-translucent button hovering on her screen. When she does this the words that are currently displayed on her screen are replaced with an overlay that has new, clearer text.

To illustrate the application of a low-literate adult as a user, the following example is provided. In this example, Tom is a construction worker with only a grade 12 education, completed three decades ago. He recently lost his job and has been trying to navigate the new world of online job applications. Many of the forms, instructions, and even questions to answer about why he wants the job, what skills he brings to the table, some of his experiences, as well as proficiency-evaluating skill-testing questions cause him to panic. Tom didn't even think panic attacks were real until he had one sitting at the desktop computer at his local library.

Thankfully, his local community career centre has content conversion system 100 downloaded on their desktops. Tom worked with one of the staff career path navigators to find a job he thinks he would be perfectly qualified for at the city hall helping do on-site assessments of current construction projects. While filling out the job application there were a lot of proficiency questions with complex words that Tom couldn't fully read. He used the content conversion button on the computer while filling out the application, sometimes just re-writing the questions so he was able to read them more easily. Other times he would have the application read him both the original question text and the transformed simplified version. Content conversion system 100 was even able to replace the original text with more common construction lingo that Tom was more familiar with than formal language. Most of the time, it turned out he knew the words to hear them, but just couldn't read them as he often only ever verbally communicated about those concepts. He was able to complete the job application fully on his own. Two weeks later he interviewed and the next day he got the job.

To illustrate the application of a business as a user for internal application, the following example is provided. In this example, Navneet is the VP Legal Affairs for a big bank. She oversees compliance and regulation for the investment arm of the bank. Every year 200 staff members under her portfolio must participate in mandatory training from the Securities and Exchanges Commission (SEC). While they have an 80% pass rate on the first try of the required annual training test, Navneet suspects that her staff don't fully understand the implications of the training. She conducted a comprehension text just 3 months after the SEC test and much to her unsurprised dismay, only 43% of her staff was able to recall and correctly respond to situational questions.

Luckily Navneet purchased content conversion system 100 licenses for all 200 of her staff members who must participate in this training. They are able to swap the content of the SEC training and its training test into everyday language. The pass rate for the SEC test increased to 95% on the first try and her ongoing internal testing jumped up to 88%. She also found that staff were using content conversion system 100 on certain clauses within various trading documents throughout the year. This led to an increase in reporting of suspicious deals that would have breached SEC rules saving the firm $40 M in penalties that year.

To illustrate the application of a business as a user for external application, the following example is provided. In this example, Salim is the COO overseeing Marketing at a large insurance company. A hot, new insurance company has been woo-ing away their small business clients. Only 12% have not renewed for the next year, but Salim is a smart and savvy businessman who knows that this is only the beginning unless they can better relate to their clients who run barbershops, restaurants, lawn care companies, pawn shops, etc.

Luckily, Salim bought content conversion 100 licenses for his entire communications & marketing team, plus a few for every business unit. Now when business units are preparing documents using their lingo for that specific insurance product they can transform the draft right in their document processor (e.g., Google Docs). This allows the business units to send pre-simplified drafts to the communications & marketing team to review. It also automatically applies corporate dictionary, style sheets, style guide principles so the documents are streamlined with the organizational style, tone, and preferred language. Communications & marketing will also run the draft through content conversion system 100 by pushing the button in their word processor, given each user has some level of personalization to their algorithms. Front line staff reported that current clients felt strong connection to the insurance company and that they were trying to help the business owners truly understand their insurance policies. As a result Salim only lost 7% of clients in the next year and actually grew their client base by 2% the following year.

To illustrate the application of a tech company as a user, the following example is provided. In this example, Yvette runs a chatbot start-up that can answer almost any medical question after learning from the entire Harvard, Yale, and Johns Hopkins medical schools' curriculums. Her technology has been deployed in low-income communities to help them better understand how to self-triage issues rather than always going to the hospital. They are able to leverage walk-in clinics, family doctors, specialists, and hospitals depending on the issue. Yvette has found that some people find the medical language very sanitized, lacking human tone, and often still too complicated to understand even though it is the correct information.

Luckily, Yvette has integrated content conversion system 100 into her chatbot technology. Now the chatbot will respond and mirror the type of language used to ask it questions. If someone uses a lot of slang and local colloquialisms, the chatbot will mirror that language and adjust the medical information accordingly. Imagine learning about the chronic lung condition COPD using language you might hear in rap songs by Nas & Tupac. If someone uses broken English and mixed up sentence structure, again the chatbot now knows to respond using very short sentences and lots of bulleted lists and numbered steps. Yvette was able to raise a record-breaking Series B financing round because of these improvements and personalizations because of licensing content conversion technology right into their chatbot.

To illustrate the application of a government entity as a user, the following example is provided. In this example, before new legislation can be passed governments have to do public consultations. Nathaniel is a new MPP looking to pass some water-protection legislation. Even people working in the field can barely make heads or tails of the legal language used. Nathaniel is frustrated because his constituents in Wawa, whom the legislation will impact the most, haven't provided much feedback on the bill, largely because they can't.

Luckily, Nathaniel bought content conversion system 100 joint technology and services support to have the entire bill swapped to two clearer versions. These new versions were circulated before a town hall that Nathaniel held in Wawa. There was a line out the door with local citizens ready, willing, and able to provide valuable tweaks, ideas, and suggestions for the legislation. With the new edits, Nathaniel successfully passed the bill in record time.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented method for transforming comprehensibility of text, comprising:
receiving a body of text;
partitioning the body of text into hierarchical syntactic and semantic segments;
determining an initial comprehensibility level of the body of text, based on one or more metrics, the metrics comprising vocabulary, grammatical structure, voice, verb usage and formatting of the body of text;
receiving a target comprehensibility level for the metrics;
for each of a plurality of measures of complexity, the measures of complexity including semantics and syntax:
generating at least one transformation of that measure of complexity for a segment of the body of the text, based at least in part on the initial comprehensibility level and the target comprehensibility level;
determining a confidence level for the transformation; and
upon the confidence level being greater than a predetermined threshold, performing the transformation on the segment of the body of text to generate a revised body of text; and
determining a revised comprehensibility level for the revised body of text based on each transformation performed on the body of text.

2. The computer-implemented of claim 1, wherein the syntactic segments comprise structural treebanks.

3. The computer-implemented of claim 1, wherein the semantic segments comprise dependency treebanks.

4. The computer-implemented of claim 1, wherein the initial comprehensibility level is based at least in part on a density of clauses in the body of text, a density of content words in the body of text, and a ratio of whitespace in the body of text.

5. The computer-implemented of claim 1, wherein the density of clauses in the body of text is based at least in part on a number of independent clauses in the body of text, a number of dependent clauses in the body of text, a number of prepositional phrases in the body of text, and a number of sentences in the body of text.

6. The computer-implemented of claim 1, wherein the density of content words is based at least in part on a number of content words in the body of text and a number of total words in the body of text.

7. The computer-implemented of claim 1, wherein the ratio of whitespace in the body of text is based at least in part on a total number of characters in the body of text, and a number of whitespace characters in the body of text.

8. The computer-implemented of claim 1, wherein the transformation of syntax comprises one or more of changing sentence structure of the segment of the body of text and a replacement of word dependencies.

9. The computer-implemented of claim 1, wherein the transformation of semantics comprises one or more of a replacement of voice usages, a replacement of verb tense, and a replacement of vocabulary.

10. The computer-implemented of claim 1, wherein the transformation of semantics comprises:
identifying a synset of a word in the segment, the synset including a set of synonyms for the word, each synonym associated with a numerical indicator of a comprehensibility level of that synonym;
replacing the word with a replacement synonym from the synset; and
revising the numerical indicator associated with the replacement synonym.

11. The computer-implemented of claim 1, wherein the measures of complexity include presentation of the body of text.

12. The computer-implemented of claim 11, wherein the presentation of the body of text includes at least one of formatting, whitespace, sizing, and spacing.

13. The computer-implemented of claim 12, wherein the transformation of presentation comprises a change of at least one of formatting, whitespace, sizing, and spacing.

14. The computer-implemented of claim 1, wherein the confidence level is based at least in part on a number of users that have accepted the transformation and a number of users that have rejected the transformation.

15. The computer-implemented of claim 1, wherein the revised comprehensibility level is based at least in part on a density of clauses in the revised body of text, a density of content words in the revised body of text, and a ratio of whitespace in the revised body of text.

16. The computer-implemented of claim 1, further comprising: determining an initial readability level of the body of text, based on one or more metrics, the metrics comprising vocabulary, grammatical structure, voice, verb usage and formatting of the body of text; receiving a target readability level for the metrics; and
for each of the plurality of measures of complexity:
generating at least one transformation in that measure of complexity for a segment of the body of the text, based at least in part on the initial readability level and the target readability level;
determining a confidence level for the transformation; and
upon the confidence level being greater than a predetermined threshold, performing the transformation on the segment of the body of text to generate the revised body of text; and
determining a revised readability level for the revised body of text based on each transformation performed on the body of text.

17. The computer-implemented of claim 16, wherein the initial readability level is based at least in part on a total number of words in the body of text, a total number of sentences in the body of text, and a total number of syllables in the body of text.

18. The computer-implemented of claim 1, further comprising: for each of the plurality of measures of complexity: upon the confidence level being less than the predetermined threshold, displaying the transformation to a user, receiving an input indicating whether the user accepts the transformation, updating the confidence level of the transformation based on the input, and performing the transformation on the segment of the body of text when the user accepts the transformation.

19. The computer-implemented of claim 1, further comprising: tracking user interactions of the user, and wherein the generating the at least one transformation is based at least in part on the user interactions.

20. A computer-implemented method for determining comprehensibility of text, comprising:
receiving a body of text;
transform the body of text into segments;
for each of the segments:
evaluating a number of independent clauses, a number of dependent clauses, and a number of prepositional phrases in the segment;
determining a density of clauses based at least in part on the number of independent clauses, the number of dependent clauses, and the number of prepositional phrases in the segment;
evaluating a number of content words and a number of total words in the segment;
determining a density of content words based at least in part on the number of content words and the number of total words in the segment;
evaluating a total number of characters and a number of whitespace characters in the segment;
determining a ratio of whitespace based at least in part on the total number of characters and the number of whitespace characters in the segment; and
assign a relative weighting to each of the density of clauses, the density of content words, and the ratio of whitespace; and
determining a comprehensibility level of the body of text based at least in part on the weighted density of clauses, the weighted density of content words and the density of the ratio of whitespace of each of the segments.
